(19) United States
(12) Patent Application Publication
(10) Pub. No.: US 2026/0322920 A1
(43) Pub. Date: Oct. 15, 2026

(54) System and Method for Predictive Engagement Optimization With Continuous Learning and Intelligent Lead Routing

(71) Applicant: TapText llc, Coral Springs, FL (US)

(72) Inventor: Steve Doumar, Fort Lauderdale, FL (US)

(21) Appl. No.: 19/712,342

(22) Filed: Jun. 18, 2026

Related U.S. Application Data
(63) Continuation-in-part of application No. 19/705,642, filed on Jun. 11, 2026.
Application No. 19/705,642 is a continuation-in-part of application No. 19/683,929, filed on May 21, 2026.
Application No. 19/683,929 is a continuation-in-part of application No. 19/441,824, filed on Jan. 6, 2026.
Application No. 19/441,824 is a continuation of application No. 17/874,209, filed on Jul. 26, 2022, now Pat. No. 12,519,888.
Application No. 17/874,209 is a continuation-in-part of application No. 17/865,814, filed on Jul. 15, 2022, now Pat. No. 12,211,070.
Application No. 17/865,814 is a continuation-in-part of application No. 17/229,251, filed on Apr. 13, 2021, now abandoned.
Application No. 17/229,251 is a continuation-in-part of application No. 17/209,474, filed on Mar. 23, 2021, now Pat. No. 11,599,916.
Application No. 17/209,474 is a continuation-in-part of application No. 17/208,059, filed on Mar. 22, 2021, now Pat. No. 11,562,407.
Application No. 17/208,059 is a continuation-in-part of application No. 17/191,977, filed on Mar. 4, 2021, now abandoned.
Application No. 17/191,977 is a continuation-in-part of application No. 17/190,260, filed on Mar. 2, 2021, now Pat. No. 11,532,020.
Application No. 17/190,260 is a continuation-in-part of application No. 17/153,426, filed on Jan. 20, 2021, now abandoned.
Application No. 19/705,642 is a continuation-in-part of application No. 18/586,473, filed on Feb. 24, 2024.
Application No. 18/586,473 is a continuation-in-part of application No. 18/185,993, filed on Mar. 17, 2023, now Pat. No. 11,995,639.
Application No. 18/185,993 is a continuation of application No. 17/409,841, filed on Aug. 24, 2021, now Pat. No. 11,610,193.
Application No. 17/409,841 is a continuation-in-part of application No. 17/360,731, filed on Jun. 28, 2021, now Pat. No. 11,871,308.
Application No. 17/360,731 is a continuation-in-part of application No. 17/229,251, filed on Apr. 13, 2021, now abandoned.
Application No. 17/229,251 is a continuation-in-part of application No. 17/085,931, filed on Oct. 30, 2020, now Pat. No. 11,055,736.
(60) Provisional application No. 63/154,357, filed on Feb. 26, 2021.
(60) Provisional application No. 63/166,391, filed on Mar. 26, 2021.
(60) Provisional application No. 63/211,496, filed on Jun. 16, 2021.

(51) Int. Cl. H04M 3/51; H04L 51/02; H04M 1/72436

(52) U.S. Cl. CPC H04M 3/5191; H04L 51/02; H04M 1/72436

(57) ABSTRACT

A system and method for predictive engagement optimization with continuous learning and intelligent lead routing, combining persistent phone-number-anchored identity management with machine learning-based engagement decision engines to determine optimal user engagement strategies. The system maintains longitudinal identity profiles that compound contextual intelligence across multiple interactions, generates feature representations from accumulated data, and applies trained engagement models to predict next-best actions and preferred communication channels for each user. An intelligent lead routing engine evaluates predicted conversion probabilities, real-time resource availability, and historical performance metrics to optimize lead distribution across call centers, sales agents, automated chat systems, and customer relationship management platforms. The system captures engagement outcomes including message delivery, opens, clicks, responses, and conversions, feeds this data into continuous learning pipelines that train and validate improved models, and deploys updated models back into production systems, creating self-improving intelligence that progressively enhances engagement effectiveness and conversion rates over time.

### CROSS-REFERENCE TO RELATED APPLICATIONS

Priority is claimed in the application data sheet to the following patents or patent applications, each of which is expressly incorporated herein by reference in its entirety:
Ser. No. 19/705,642
Ser. No. 19/683,929
Ser. No. 19/441,824
Ser. No. 17/874,209
Ser. No. 17/865,814
Ser. No. 17/229,251
63/166,391
Ser. No. 17/209,474
Ser. No. 17/208,059
Ser. No. 17/191,977
Ser. No. 17/190,260
Ser. No. 17/153,426
63/154,357
Ser. No. 18/586,473
Ser. No. 18/185,993
Ser. No. 17/409,841
Ser. No. 17/360,731
Ser. No. 17/085,931
63/211,496
Ser. No. 19/696,642
Ser. No. 18/631,042
Ser. No. 18/593,911
63/519,562
63/519,559

### BACKGROUND OF THE INVENTION

### Field of the Art

The present invention relates to the field of computer-based communication systems, and more specifically to the field of marketing and promotions using computer-based communication systems.

### Discussion of the State of the Art

Modern customer engagement systems face significant challenges in optimizing communication strategies and resource allocation for individual users across diverse interaction contexts. Current systems treat engagement decisions as isolated events determined by static rules or simple heuristics, selecting communication channels based on technical availability rather than predicted effectiveness and routing leads through round-robin assignment or basic availability checking rather than conversion-optimized intelligence. When a business seeks to engage a prospective customer through messaging channels, existing platforms typically apply uniform messaging strategies to all users regardless of their prior engagement history, behavioral patterns, demonstrated channel preferences, or predicted responsiveness to different types of engagement actions. This one-size-fits-all approach results in inefficiencies such as delivery of product offers to users unlikely to convert, utilizing expensive Rich Communication Services delivery for users who respond better to simple SMS, and missing opportunities to engage users through their preferred channels at their optimal engagement times.

Furthermore, current engagement systems lack the ability to determine the next best action for a user based on predictive modeling that considers accumulated identity context, interaction history, and real-time behavioral signals. Existing platforms typically execute predetermined message sequences defined at campaign creation time, sending identical content to all campaign participants without dynamic adjustment based on individual user characteristics or observed engagement patterns. The absence of predictive action selection means that businesses cannot systematically identify which users should receive product offers versus educational content, which users warrant immediate routing to sales agents versus automated chat systems, or which users would benefit from loyalty incentives versus transactional interactions, forcing reliance on broad segmentation rules that fail to capture individual-level variation in engagement propensity and conversion likelihood.

Additionally, existing systems do not implement intelligent lead routing based on predicted conversion probability combined with real-time resource availability and historical performance analysis. When qualified leads are generated through digital interactions, current platforms typically route them through simple assignment mechanisms such as round-robin distribution that cycles through available agents regardless of conversion skill differences, or availability-based routing that directs leads to whoever is idle without considering match quality between lead characteristics and agent capabilities. The lack of conversion-optimized routing means that businesses cannot systematically maximize return on expensive sales resources, often routing low-probability leads to premium agents while directing high-value opportunities to generic call center queues or automated systems ill-equipped to capitalize on the conversion potential.

Current systems additionally treat each engagement interaction as a terminal event rather than as a training example that should inform future engagement decisions through continuous learning. Although some platforms store interaction histories and outcome data, they rarely feed this information back into predictive models that adapt engagement strategies based on observed results. When users respond positively to certain engagement actions or channels, existing systems do not automatically adjust future engagement probabilities to favor similar approaches for users with comparable characteristics. This absence of continuous learning means that engagement effectiveness stagnates rather than compounds over time, with platforms unable to systematically improve their action selection, channel optimization, and routing decisions as they accumulate more evidence about what strategies work for different users in different contexts.

What is needed is a system and method that applies trained machine learning models to determine next-best engagement actions for individual users based on accumulated identity profiles and real-time contextual signals, that dynamically selects communication channels based on predicted engagement effectiveness rather than mere technical availability, that implements intelligent lead routing combining conversion probability predictions with real-time availability monitoring and historical performance analysis, and that continuously captures engagement outcomes including message delivery, opens, clicks, responses, and conversions, feeds this outcome data into model training pipelines, validates improved models through rigorous testing, and deploys updated models back into production engagement systems to create a self-improving intelligence that progressively enhances engagement effectiveness and conversion rates over time.

### SUMMARY OF THE INVENTION

Accordingly, the inventor has conceived and reduced to practice a system and method for a system and method for predictive engagement optimization with continuous learning and intelligent lead routing.

According to a preferred embodiment, a system for predictive engagement optimization with continuous learning and intelligent lead routing, comprising: a user device comprising at least a first plurality of programming instructions stored in the memory of, and operating on at least one processor of, a first computing device, wherein the first plurality of programming instructions, when operating on the at least one processor, cause the first computing device to: interact with digital activation assets over a network; transmit an interaction event comprising a phone number and contextual data; and receive an engagement message via a messaging protocol; a messaging gateway comprising at least a second plurality of programming instructions stored in the memory of, and operating on at least one processor of, a second computing device, wherein the second plurality of programming instructions, when operating on the at least one processor, cause the second computing device to: support multiple messaging protocols; receive delivery instructions from an engagement decision server; deliver the engagement message to the user device using a selected messaging protocol; and capture engagement outcomes comprising message delivery confirmations, message open events, user responses, link clicks, and conversion events; an engagement decision server comprising at least a third plurality of programming instructions stored in the memory of, and operating on at least one processor of, a third computing device, wherein the third plurality of programming instructions, when operating on the at least one processor, cause the third computing device to: receive the interaction event from the user device comprising the phone number and contextual data; retrieve an identity profile from an identity database using the phone number as a primary identifier, wherein the identity profile comprises accumulated interaction history and engagement patterns; generate a feature representation derived from the identity profile and the contextual data; apply a trained engagement model to the feature representation to determine a predicted next engagement action and a preferred communication channel; evaluate communication channel capability information associated with the user device; select the messaging protocol based on the preferred communication channel and the communication channel capability information; generate the engagement message corresponding to the predicted next engagement action; transmit delivery instructions to the messaging gateway; receive the engagement outcomes from the messaging gateway; aggregate the engagement outcomes with the feature representation to create labeled training examples; and update the trained engagement model using the labeled training examples; and a lead routing server comprising at least a fourth plurality of programming instructions stored in the memory of, and operating on at least one processor of, a fourth computing device, wherein the fourth plurality of programming instructions, when operating on the at least one processor, cause the fourth computing device to: apply a conversion prediction model to the identity profile to compute a predicted conversion probability; evaluate availability status of multiple lead destinations; determine a routing destination based on the predicted conversion probability and the availability status; and transmit lead data to the determined routing destination.

According to another preferred embodiment, a method for predictive engagement optimization with continuous learning and intelligent lead routing, comprising the steps of: interacting with digital activation assets over a network, using a user device; transmitting an interaction event comprising a phone number and contextual data, using a user device; receiving an engagement message via a messaging protocol, using a user device; supporting multiple messaging protocols, using a messaging gateway; receiving delivery instructions from an engagement decision server, using a messaging gateway; delivering the engagement message to the user device using a selected messaging protocol, using a messaging gateway; capturing engagement outcomes comprising message delivery confirmations, message open events, user responses, link clicks, and conversion events, using a messaging gateway; receiving the interaction event from the user device comprising the phone number and contextual data, using an engagement decision server; retrieving an identity profile from an identity database using the phone number as a primary identifier, wherein the identity profile comprises accumulated interaction history and engagement patterns, using an engagement decision server; generating a feature representation derived from the identity profile and the contextual data, using an engagement decision server; applying a trained engagement model to the feature representation to determine a predicted next engagement action and a preferred communication channel, using an engagement decision server; evaluating communication channel capability information associated with the user device, using an engagement decision server; selecting the messaging protocol based on the preferred communication channel and the communication channel capability information, using an engagement decision server; generating the engagement message corresponding to the predicted next engagement action, using an engagement decision server; transmitting delivery instructions to the messaging gateway, using an engagement decision server; receiving the engagement outcomes from the messaging gateway, using an engagement decision server; aggregate the engagement outcomes with the feature representation to create labeled training examples, using an engagement decision server; update the trained engagement model using the labeled training examples, using an engagement decision server; apply a conversion prediction model to the identity profile to compute a predicted conversion probability, using a lead routing server; evaluate availability status of multiple lead destinations, using a lead routing server; determine a routing destination based on the predicted conversion probability and the availability status, using a lead routing server; and transmit lead data to the determined routing destination, using a lead routing server.

### BRIEF DESCRIPTION OF THE DRAWING FIGURES

FIG. 1 is a system diagram illustrating an RCS-based lead redirection and opt-in management system.

FIG. 2 is a system diagram illustrating an enhanced interaction control server architecture with six-service addition, according to an embodiment.

FIG. 3 is a block diagram illustrating a persistent identity profile data structure, according to an embodiment.

FIG. 4 is a state diagram illustrating a multi-state opt-in state machine, according to an embodiment.

FIG. 5 is a flowchart diagram illustrating capability-aware message construction for dual protocols, according to an embodiment.

FIG. 6 is a block diagram illustrating an exemplary system architecture for an identity-weighted token generation system 600, according to an embodiment.

FIG. 7 is a block diagram illustrating an exemplary system architecture for a consent-gated access level system, according to an embodiment.

FIG. 8 is a block diagram illustrating an exemplary system architecture for an engagement decision system with predictive model flow, according to an embodiment.

FIG. 9 is a block diagram illustrating an exemplary system architecture for a lead routing system with conversion-optimized intelligent distribution, according to an embodiment.

FIG. 10 is a block diagram illustrating an exemplary system architecture for a continuous learning and model training pipeline, according to an embodiment.

FIG. 11 illustrates an exemplary computing environment on which an embodiment described herein may be implemented.

### DETAILED DESCRIPTION OF THE INVENTION

The inventor has conceived and reduced to practice, a system and method for predictive engagement optimization with continuous learning and intelligent lead routing that transforms reactive messaging platforms into proactive, data-driven engagement systems. By maintaining persistent phone-number-anchored identity profiles that accumulate contextual intelligence across multiple interactions, the system enables each engagement decision to be informed by the complete history of a user's prior responses, channel preferences, behavioral patterns, and conversion outcomes rather than treating each contact as an isolated event. Machine learning models consume this accumulated identity data to predict which engagement actions—product offers, appointment scheduling, information requests, agent escalation, or loyalty incentives—will maximize response probability for each specific user at each specific moment. Channel selection is similarly optimized through predictive scoring that evaluates how likely each user is to engage via Rich Communication Services with interactive features, via SMS with text-based simplicity, via MMS with visual content, or via email with detailed formatting, based on historical channel response patterns rather than mere technical capability availability.

The continuous learning architecture creates a closed feedback loop wherein engagement outcomes including message delivery confirmations, open events, click-through actions, user responses, and conversion events are captured and aggregated with the feature representations that informed the original engagement decisions to create labeled training examples. These training examples feed into model training pipelines that execute gradient descent optimization, tree-building algorithms, policy gradient methods, or ensemble training procedures appropriate to the model architecture, continuously refining the parameters that govern action selection and channel scoring. Validation procedures ensure that newly trained models generalize to unseen data rather than merely memorizing training examples, applying cross-validation techniques, A/B testing simulations on historical replay data, and fairness audits across user segments before candidate models are approved for deployment. The deployment service transitions validated models into production using canary releases, blue-green deployments, or gradual rollouts that enable safe introduction of improved predictive intelligence while maintaining rollback capabilities if unexpected behaviors emerge.

Intelligent lead routing extends the predictive optimization framework to the distribution of qualified leads across downstream destinations including call centers, sales agents, automated chat systems, customer relationship management platforms, and loyalty management systems. Rather than routing leads through round-robin assignment that cycles through available agents regardless of conversion skill differences, or availability-based routing that directs leads to whoever is idle without considering match quality, the system applies conversion prediction models that compute predicted conversion probabilities for different routing destinations based on the user's identity profile, current interaction context, and historical performance patterns. A decision router synthesizes predicted conversion probabilities with real-time availability status from an availability checker that monitors agent presence, queue depths, and system connectivity, and with performance insights from a historical performance analyzer that identifies which destinations have historically produced the best conversion results for different user segments. This multi-factor optimization ensures that high-value leads are directed to resources most likely to convert them while respecting operational constraints such as queue depth limits, service level agreements, and regional assignment rules.

The compounding intelligence created through continuous learning means that engagement effectiveness improves systematically over time as the system accumulates more evidence about what strategies work for different users in different contexts. A user with no prior interaction history receives engagement decisions based on population-level patterns and default strategies, but each subsequent interaction enriches that user's identity profile with new behavioral observations, response patterns, and outcome data that enable increasingly personalized predictions. Users with extensive interaction histories benefit from engagement strategies finely tuned to their individual preferences, optimal contact times, preferred devices, and demonstrated interests, creating progressively improving experiences with reduced friction as accumulated intelligence compounds. The self-improving nature of the system creates a sustainable competitive advantage wherein businesses that consistently engage users through the platform accumulate proprietary intelligence about optimal engagement strategies that cannot be easily replicated by competitors lacking equivalent historical data and continuous learning infrastructure.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Conceptual Architecture

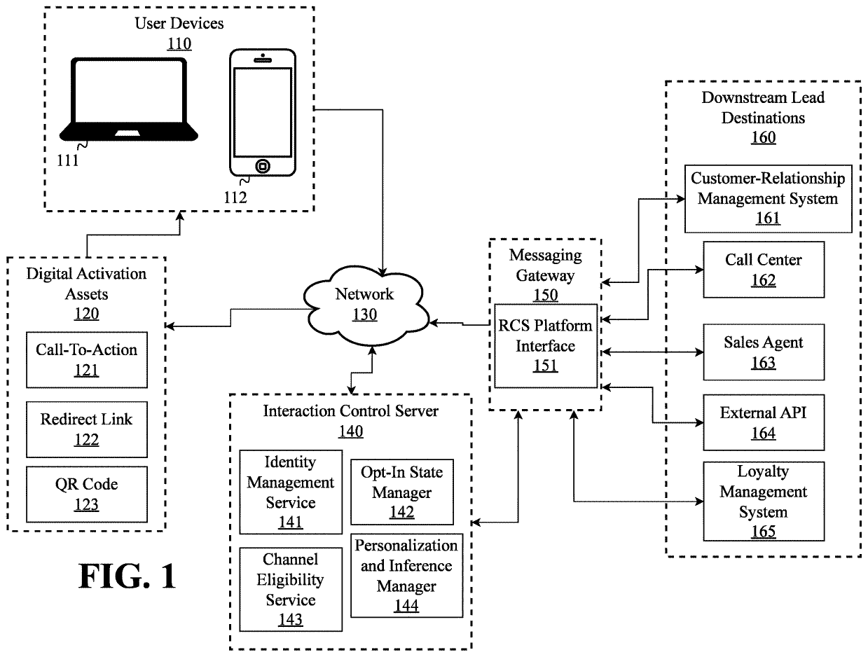

FIG. 1 is a system diagram illustrating an RCS-based lead redirection and opt-in management system using phone-number-centric identity and verified messaging channels, with detailed sub-components for identity management, opt-in state management, channel eligibility determination, and personalization, according to an embodiment.

According to the embodiment, the system comprises user devices 110, which may include a laptop or desktop computer 111 and a mobile device 112 such as a smartphone or tablet, or other user devices as may become available in the future, if they are capable of communications with other networked devices. User devices 110 are configured to interact with digital activation assets 120 over a network 130 and are further configured to receive and display messages delivered via multiple messaging protocols, to transmit interaction signals and user responses to the system, and to execute user interactions including tapping, clicking, scanning, or otherwise using digital activation assets. User devices 110 may have varying communication capabilities including support for SMS, MMS, RCS, email, or web-based communication, and may provide device-identifying information such as phone numbers, email addresses, device identifiers, platform information, and messaging client capabilities that enable the system to establish user identity and determine appropriate communication protocols.

Digital activation assets 120 may comprise various trigger mechanisms including a call-to-action button 121, a redirect link 122, and a QR code 123, each of which may be embedded in advertisements, web pages, physical media, or messages to initiate user engagement with the system. Digital activation assets 120 are configured to be delivered to user devices 110 through multiple channels and formats, to encode campaign identifiers, product or service information, or opt-in context, and to generate interaction signals when accessed or activated by users. The digital activation assets 120 may be format-agnostic and capable of being delivered via email, SMS, MMS, RCS messages, web pages, or embedded within other digital content, with presentation and functionality adapting to the capabilities of the receiving user device 110 and the communication protocol used for delivery.

The network 130 may comprise one or more communication networks including the Internet, cellular networks, packet-switched data networks, or other network infrastructure capable of transmitting data between components of the system. Network 130 is configured to support bidirectional communication between user devices 110, messaging gateway 150, and interaction control server 140, to transmit messages using multiple protocols including SMS, MMS, RCS, email, and web-based communication, and to convey interaction signals, user responses, contextual metadata, device capabilities, and protocol information between system components.

User devices 110 communicate with an interaction control server 140 via network 130 and messaging gateway 150, wherein the interaction control server 140 operates to manage opt-in events, determine messaging channel eligibility, coordinate session state, and control lead redirection operations as described in various embodiments herein. According to the embodiment, the interaction control server 140 comprises multiple sub-components or integrated services that collectively provide identity management, opt-in state management, channel eligibility determination, and personalization capabilities.

The interaction control server 140 comprises an identity management service 141, which is configured to maintain persistent user identity profiles anchored to phone numbers as primary identifiers, to store and manage identity records comprising interaction history, device associations, communication preferences, opt-in records, engagement patterns, and accumulated contextual observations, to resolve user identity from phone numbers, email addresses, device identifiers, or other identifying information received during interactions, to merge new contextual data with existing identity profiles upon each user interaction, to enrich identity profiles with inferred preferences and behavioral patterns derived from accumulated data, and to provide identity data to other components of the interaction control server 140 and to downstream lead destinations 160 subject to opt-in scope and privacy constraints. The identity management service 141 treats phone numbers as identity DNA, creating a stable anchor for persistent user identification across devices, channels, sessions, and time periods, enabling the accumulation of contextual intelligence that compounds with each interaction.

The interaction control server 140 further comprises an opt-in state manager 142, which is configured to capture and record opt-in events triggered by user interactions with digital activation assets 120, to maintain opt-in state information using a state-based model rather than binary permission flags, to associate opt-in events with contextual metadata including activation asset identifiers, campaign parameters, timestamps, device characteristics, and consent scope parameters, to manage multiple opt-in states indicating different levels or types of messaging eligibility including no opt-in, basic messaging permission, enhanced messaging capability permission, and verified or branded messaging context permission, to enforce state transitions in response to user actions, elapsed time, campaign context changes, or external verification processes, to consult opt-in state when determining whether messages may be sent and which messaging protocols and features may be enabled, to log and retain opt-in events and state transitions for audit, reporting, and compliance purposes, and to provide opt-in state information to channel eligibility service 143 and other components for use in downstream processing decisions.

The interaction control server 140 further comprises a channel eligibility service 143, which is configured to determine which messaging channels and protocols are eligible for use in a given interaction based on evaluation of opt-in state from opt-in state manager 142, device capabilities, carrier enablement, platform support, business verification status, and campaign configuration, to evaluate channel eligibility as a distinct processing step occurring after opt-in capture and prior to message delivery, to conditionally enable enhanced messaging capabilities including RCS only when eligibility criteria are satisfied, to apply prioritization rules when multiple channels are eligible to select a preferred protocol based on feature richness, expected user experience, reliability, or prior interaction history, to dynamically reevaluate eligibility over time or across interaction steps in response to user actions, changes in device or platform configuration, completion of verification processes, or elapsed time, to communicate with RCS platform interface 151 to negotiate and retrieve RCS capability information, to maintain capability cache storing previously retrieved capability profiles associated with devices, users, or messaging identifiers, to select fallback messaging protocols when enhanced capabilities are unavailable while preserving interaction continuity and attribution, and to provide channel and protocol selection decisions to messaging gateway 150 for message delivery.

The interaction control server 140 further comprises a personalization and inference manager 144, which is configured to apply inference logic and machine learning algorithms to accumulated identity data to derive implicit user preferences without requiring explicit confirmation, to analyze interaction patterns across time to infer preferred communication times, preferred devices, preferred protocols, and product or service interests, to generate behavioral models predicting user engagement propensity and responsiveness, to continuously refine understanding of user preferences and behavior patterns with each new interaction using phone number as stable identity anchor, to create compounding intelligence that improves personalization and targeting effectiveness over time, to determine optimal future contact strategies including protocol selection, timing, device targeting, and message personalization based on accumulated intelligence, to provide personalization recommendations to channel eligibility service 143 and identity management service 141 for use in message preparation and delivery, to generate enriched user context for transmission to downstream lead destinations 160, and to enable progressively improving engagement experiences with reduced friction as the system accumulates more data about each user identity. The personalization and inference manager 144 may utilize artificial intelligence, machine learning, natural language processing, behavioral analytics, or other computational intelligence techniques to extract insights from accumulated interaction data and to optimize engagement strategies dynamically.

Interaction control server 140 is further configured to receive and process digital activation asset interactions forwarded from messaging gateway 150, to determine user identity and communication preferences using contextual data including device type, platform information, messaging protocol used, and historical interaction patterns by coordinating between identity management service 141, opt-in state manager 142, channel eligibility service 143, and personalization and inference manager 144, to maintain persistent user identity profiles associated with phone numbers or other identifiers, to accumulate and update contextual information about users over time without requiring repeated explicit confirmation, to select appropriate messaging protocols and communication methods for future interactions based on accumulated context and implicit preferences, to generate and format data for transmission to downstream lead destinations 160 using preferred or preconfigured formatting or data transmission methods such as proprietary APIs or generalized JSON objects, and to enable frictionless future communications by automatically routing messages over preferred communication media and protocols to preferred devices using all available context.

A messaging gateway 150 is communicatively coupled to both the interaction control server 140 and the network 130. The messaging gateway 150 may be communicatively coupled to the interaction control server 140 through various architectural configurations, including: as a directly coupled component wherein messaging gateway 150 and interaction control server 140 are integrated within the same computing system or physically co-located hardware; as a sub-component wherein messaging gateway 150 operates as a functional software application or service, or physical device such as an ASIC or specialized chip, within interaction control server 140, or vice versa; through direct on-premises connection wherein messaging gateway 150 and interaction control server 140 are separate physical devices connected via local area network, direct physical connection, or other on-premises infrastructure; or through network-based connection wherein messaging gateway 150 and interaction control server 140 are decoupled and communicate over one or more networks 130 including the Internet, wide area networks, or other remote communication infrastructure. Regardless of the specific coupling architecture employed, messaging gateway 150 and interaction control server 140 are configured to exchange data bidirectionally to coordinate messaging operations, channel selection, and interaction processing.

The messaging gateway 150 comprises an RCS platform interface 151, which is configured to communicate with external RCS platform services, carrier RCS networks, and RCS business messaging providers, to negotiate RCS capabilities for specific phone numbers or devices by querying capability endpoints or retrieving capability information from platform services, to retrieve capability profiles indicating supported RCS features including rich cards, interactive buttons, suggested replies, rich media, branded sender identity, persistent sessions, and any feature limitations or restrictions, to verify business sender status and retrieve verified identity information including registered business names, brand logos, and verification badges, to transmit RCS messages with appropriate formatting, branding, and interactive elements based on negotiated capabilities, to receive RCS message delivery confirmations, read receipts, and user interaction events, to detect RCS delivery failures or capability unavailability conditions, and to provide capability information and delivery status to channel eligibility service 143 within interaction control server 140 for use in eligibility determination and fallback decisions. The RCS platform interface 151 enables the messaging gateway 150 to leverage enhanced RCS features when available while maintaining robust fallback capabilities when RCS is unsupported or unavailable.

Messaging gateway 150 is configured to support multiple messaging protocols including Rich Communication Services (RCS), Short Message Service (SMS), and Multimedia Messaging Service (MMS), and operates to transmit messages to user devices 110 and receive inbound user responses based on channel eligibility determinations and capability negotiations performed by interaction control server 140 through coordination between channel eligibility service 143 and RCS platform interface 151. Messaging gateway 150 is further configured to receive digital activation assets from interaction control server 140 for delivery to users, to determine messaging protocol and methodology to use for each user based on user signup contact information and device capabilities in coordination with channel eligibility service 143, to deliver digital activation assets to user devices 110 in formats appropriate to the selected protocol and receiving device, to receive digital activation asset interactions from user devices 110 including URL accesses from referral links, data from QR code scans, button presses, or other user-initiated actions, to capture and forward interaction events along with contextual metadata to interaction control server 140, to transmit comprehensive contextual data including the interaction content, messaging protocol used, device type, platform information, carrier network, geographic or network location data, timestamp information, and any other available contextual metadata, to receive inbound user interactions and responses during ongoing communications, and to route such interactions back to interaction control server 140 with all available context for processing by identity management service 141, opt-in state manager 142, and personalization and inference manager 144, and for potential forwarding to downstream lead destinations 160.

The system further comprises downstream lead destinations 160, which may include a customer relationship management system 161, a call center 162, a sales agent 163, an external API 164, and a loyalty management system 165. Downstream lead destinations 160 are configured to receive redirected leads and interaction context from interaction control server 140, enabling businesses to respond to user engagement with products or services.

The loyalty management system 165 is configured to manage loyalty programs, reward points, incentive structures, and customer engagement benefits associated with user identities maintained by identity management service 141, to track user engagement activities and assign loyalty value or points based on interactions, purchases, or other qualifying behaviors, to provide loyalty status information and available rewards to interaction control server 140 for use in message personalization and user engagement strategies, to deliver loyalty benefits including discounts, exclusive offers, or reward redemptions through messaging channels coordinated by messaging gateway 150 and interaction control server 140 without requiring users to install dedicated loyalty applications, to integrate loyalty wallet functionality directly into messaging interactions by presenting loyalty information, available rewards, and redemption options within RCS messages or other message formats when capabilities permit, to receive loyalty-relevant user actions and transactions from interaction control server 140 for loyalty account updates and reward calculations, and to enable phone-number-anchored loyalty identification wherein users are recognized and rewarded based on their phone number identity without requiring separate loyalty account credentials or application installations. The loyalty management system 165 enables persistent loyalty engagement tied to phone number identity, creating switching costs and ongoing value that compounds over time alongside the identity and preference data accumulated by identity management service 141 and personalization and inference manager 144.

Downstream lead destinations 160 are further configured to receive formatted data or requests for further user contact from interaction control server 140, wherein the received data comprises user identity information from identity management service 141, interaction context, campaign identifiers, product or service information, communication preference data derived from personalization and inference manager 144, opt-in state from opt-in state manager 142, consent information, enriched behavioral insights, and loyalty status from loyalty management system 165, to receive data about the context and identity and implicit preferences of users based on their interactions, to receive such data in formats tailored to each destination's technical capabilities using preferred or preconfigured formatting or data transmission methods such as proprietary APIs or generalized JSON objects, to save and store information on how to interact with users for future communications including preferred communication protocols, contact information, interaction history, product interests, campaign context, and opt-in state information, to access and utilize accumulated user context and preference information for ongoing relationship management and follow-up interactions, and to conduct future communications with users through messaging gateway 150 and interaction control server 140 rather than establishing direct communication channels, thereby allowing the system to preserve privacy protections by masking direct contact information between users and business resources, maintain session continuity and attribution across multiple interaction points and time periods, enable ongoing updates to user context and identity over time through identity management service 141 and personalization and inference manager 144, and ensure that all communications remain subject to opt-in state and channel eligibility determinations managed by opt-in state manager 142 and channel eligibility service 143.

The interaction control server 140 may route user interactions to one or more of the downstream lead destinations 160 based on campaign configuration, user responses, routing logic executed by channel eligibility service 143 or other routing components, availability of destination resources, user identity attributes from identity management service 141, engagement predictions from personalization and inference manager 144, or loyalty status from loyalty management system 165, while preserving session continuity, attribution data, and privacy protections across the engagement lifecycle. The routing may be performed using conditional logic that considers campaign or activation asset associations, content or type of user responses, current messaging channel and capability state, session history or interaction sequence, business rules or configuration parameters, and personalized routing strategies optimized for each user identity.

In operation, the interaction control server 140 may first establish a preferred or default communication protocol based on user device type, wherein device-identifying information such as email address, phone number, or other identifiers indicates the basic device type or communication methods available to the user. The interaction control server 140, through coordination between identity management service 141 and channel eligibility service 143, then sends out digital activation asset(s) to messaging gateway 150, which determines the messaging protocol and methodology to use for the user based on user signup contact information through consultation with channel eligibility service 143 and RCS platform interface 151, assessing device capabilities, carrier support, and platform constraints to select an appropriate channel such as email, SMS, MMS, or RCS. Digital activation assets 120 are received by user device(s) 110 in a format appropriate for the receiving device and communication channel, such as a QR code received by email address, a redirect link sent via SMS message, or a call-to-action button embedded in an RCS message delivered through RCS platform interface 151. A user may interact with one of the digital activation assets 120 using a user device 110 by tapping, clicking, scanning, or otherwise using the digital activation asset, which generates an interaction signal that is sent to messaging gateway 150 over network 130.

Messaging gateway 150 receives the digital activation asset interaction and forwards the digital asset activation/interaction and context data, including communication protocol(s) used, device type, platform information, and other available metadata, to interaction control server 140. The interaction control server 140 processes the received interaction using identity management service 141 to determine user identity and communication preferences using contextual data, which may involve matching the interaction to an existing user profile based on phone number, email address, device identifier, or other identifying information, creating a new identity profile if none exists with phone number as the persistent identity anchor, and inferring communication preferences from the protocol used, stored user profile data, or prior interaction history. The opt-in state manager 142 records an opt-in event triggered by the interaction, capturing contextual metadata and establishing or updating opt-in state information that governs subsequent messaging eligibility.

Based on the opt-in state from opt-in state manager 142, device capabilities negotiated through RCS platform interface 151, carrier support information, and verification status, the channel eligibility service 143 within interaction control server 140 determines whether RCS messaging is eligible for the interaction, consulting capability profiles and applying eligibility rules. If RCS is eligible, channel eligibility service 143 instructs messaging gateway 150 to deliver an RCS message through RCS platform interface 151 with enhanced features such as branded sender identity, rich card layout, or interactive buttons. If RCS is not eligible, channel eligibility service 143 selects an alternative protocol such as SMS or MMS while preserving interaction intent. The personalization and inference manager 144 may influence message content, timing, and presentation based on accumulated intelligence about the user identity to optimize engagement likelihood.

The interaction control server 140 sends formatted data or requests for further user contact to downstream lead destinations 160, which may include user identity information from identity management service 141, interaction context, campaign identifiers, communication preference data from personalization and inference manager 144, opt-in state information from opt-in state manager 142, and loyalty status from loyalty management system 165. Downstream lead destinations 160 save information on how to interact with the user for future communications, storing preferred communication protocols, contact information, interaction history, and consent information in customer relationship management system 161 or other data repositories.

User responses or interactions with delivered messages are received by messaging gateway 150, which sends data to interaction control server 140 comprising the interaction and all context available to the message, including protocol, device type, platform, carrier network, timestamp, and other contextual metadata. The identity management service 141 associates the response with the user's identity profile and updates accumulated contextual data. The personalization and inference manager 144 processes the new interaction data to refine behavioral models and preference predictions. The interaction control server 140 sends data about the context and identity and implicit preferences of the user based on the interaction to downstream lead destinations 160 using preferred or preconfigured formatting or data transmission methods such as proprietary APIs or generalized JSON objects.

User contact via downstream lead destinations 160 continues to go through messaging gateway 150 and interaction control server 140, allowing for updates to user context and identity over time through continuous operation of identity management service 141 and personalization and inference manager 144. Future communications with users are done over preferred communication medium and protocol determined by channel eligibility service 143 based on accumulated preference data from personalization and inference manager 144, to preferred device identified through device association tracking in identity management service 141, using all available context without asking the user to directly confirm information, thereby enabling frictionless continuation of interactions across sessions and time periods while respecting established identity managed by identity management service 141, preferences inferred by personalization and inference manager 144, and opt-in state maintained by opt-in state manager 142. Such user responses or interactions with delivered messages may trigger lead redirection actions, causing interaction control server 140 to route the engagement to one or more downstream lead destinations 160, potentially including loyalty management system 165 for loyalty program updates, while maintaining interaction context and attribution information throughout the engagement lifecycle through coordinated operation of all sub-components within interaction control server 140.

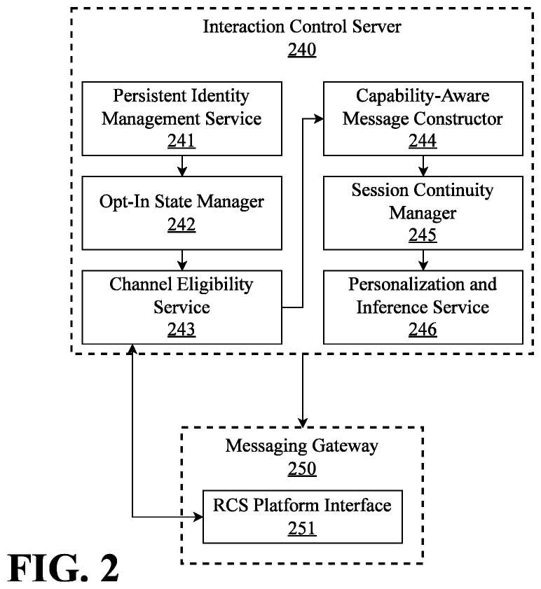

FIG. 2 is a system diagram illustrating an enhanced interaction control server architecture with six-service addition, according to an embodiment. According to the embodiment, the system comprises an interaction control server 240 containing six integrated services that provide persistent identity management, multi-state opt-in tracking, channel eligibility determination, capability-aware message construction, session continuity management, and personalization capabilities.

The interaction control server 240 comprises a persistent identity management service 241, which is configured to maintain phone-number-anchored identity profiles that persist across devices, messaging protocols, campaigns, and time periods. The persistent identity management service 241 stores and manages identity records comprising interaction history, device associations, communication preferences, opt-in records, engagement patterns, and accumulated contextual observations, and provides identity data to other services within the interaction control server 240 and to downstream lead destinations subject to opt-in scope and privacy constraints.

The interaction control server 240 further comprises an opt-in state manager 242, which is configured to capture and record opt-in events triggered by user interactions with digital activation assets, to maintain opt-in state information using a multi-state consent model rather than binary permission flags, and to associate opt-in events with contextual metadata including activation asset identifiers, campaign parameters, timestamps, device characteristics, and consent scope parameters. The opt-in state manager 242 manages multiple opt-in states indicating different levels of messaging eligibility including no opt-in, basic messaging permission, enhanced messaging capability permission, and verified or branded messaging context permission, and enforces state transitions in response to user actions, elapsed time, campaign context changes, or external verification processes.

The interaction control server 240 further comprises a channel eligibility service 243, which is configured to determine which messaging channels and protocols are eligible for use in a given interaction based on evaluation of opt-in state from the opt-in state manager 242, device capabilities, carrier enablement, platform support, business verification status, and campaign configuration. The channel eligibility service 243 evaluates channel eligibility as a distinct processing step occurring after opt-in capture and prior to message delivery, conditionally enables enhanced messaging capabilities including RCS only when eligibility criteria are satisfied, and communicates with RCS platform interface 251 within messaging gateway 250 to negotiate and retrieve RCS capability information.

The interaction control server 240 further comprises a capability-aware message constructor 244, which is configured to format messages based on selected protocol and capabilities determined by the channel eligibility service 243, to adapt rich features such as cards, buttons, and media to protocol constraints, to reconstruct interaction intent for fallback protocols when enhanced capabilities are unavailable, and to preserve core interaction logic across all message formats. The interaction control server 240 further comprises a session continuity manager 245, which is configured to assign and maintain session identifiers across interactions, to handle delivery failures and trigger protocol transitions, to preserve conversation context and attribution across channel changes, and to match user responses to sessions despite protocol variations. The interaction control server 240 further comprises a personalization and inference service 246, which is configured to apply inference logic and machine learning algorithms to accumulated identity data to derive implicit user preferences without requiring explicit confirmation, to analyze interaction patterns across time to infer preferred communication times, preferred devices, preferred protocols, and product or service interests, and to continuously refine understanding of user preferences and behavior patterns with each new interaction.

The messaging gateway 250 is communicatively coupled to the interaction control server 240 and comprises an RCS platform interface 251, which is configured to communicate with external RCS platform services, carrier RCS networks, and RCS business messaging providers, to negotiate RCS capabilities for specific phone numbers or devices by querying capability endpoints, and to transmit RCS messages with appropriate formatting, branding, and interactive elements based on negotiated capabilities. The messaging gateway 250 is further configured to support multiple messaging protocols including SMS and MMS in addition to RCS, to receive delivery instructions from the interaction control server 240, and to deliver messages to user devices using the selected messaging protocol as determined by the channel eligibility service 243.

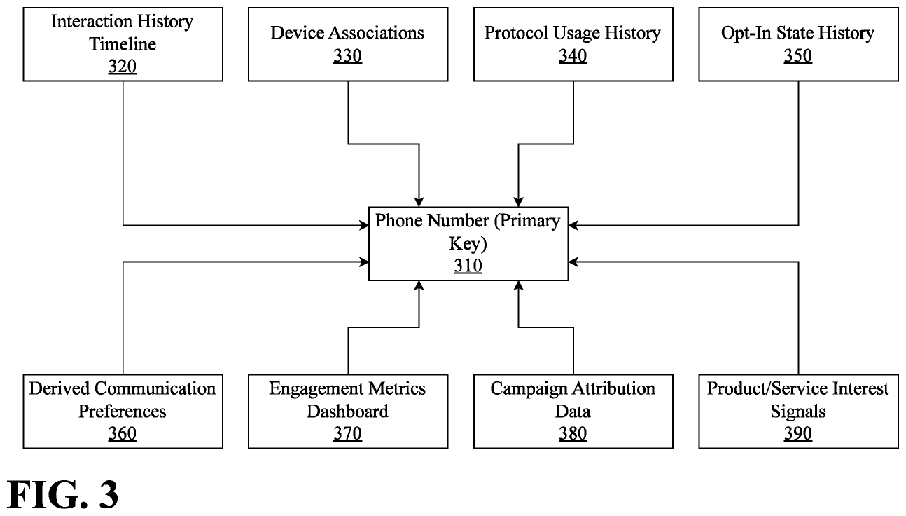

FIG. 3 is a block diagram illustrating a persistent identity profile data structure, according to an embodiment. The diagram shows the constituent elements of an identity record that is maintained by the persistent identity management service and anchored to a phone number as a stable identifier across devices, protocols, campaigns, and time periods.

At the center of the identity profile structure is a phone number 310, which functions as the primary key and identity anchor. The phone number 310 serves as a persistent identifier that remains stable across user interactions regardless of device changes, messaging protocol variations, or campaign contexts, enabling the system to accumulate and retrieve contextual intelligence associated with a single user identity over extended time periods.

The identity profile comprises an interaction history timeline 320, which stores a chronological record of all interactions between the user and the system including message exchanges, activation asset engagements, protocol usage, and response patterns. The identity profile further comprises device associations 330, which track multiple devices that have been linked to the phone number identity, enabling the system to recognize and optimize communications across different user devices. The identity profile further comprises protocol usage history 340, which records which messaging protocols have been successfully used for communications with this identity, including information about RCS capability, SMS/MMS usage, and protocol transition events. The identity profile further comprises opt-in state history 350, which maintains a temporal record of consent state transitions, capturing when opt-in events occurred, what consent scope was granted, which activation assets triggered opt-in, and how consent status has evolved over time.

The identity profile further comprises derived communication preferences 360, which store inferred preferences about optimal communication timing, preferred protocols, preferred devices, and engagement patterns as determined through analysis of accumulated interaction data without requiring explicit user confirmation. The identity profile further comprises engagement metrics dashboard 370, which tracks quantitative measures of user engagement including response rates, interaction frequency, message open rates, conversion events, and other behavioral indicators. The identity profile further comprises campaign attribution data 380, which associates interactions and outcomes with specific marketing campaigns, activation assets, and promotional initiatives to enable performance measurement and optimization. The identity profile further comprises product or service interest signals 390, which accumulate indications of user interest in particular products, services, categories, or features based on interaction patterns, activation asset engagements, and behavioral analysis.

Together, these data elements comprise a comprehensive identity profile that compounds in intelligence and richness with each new interaction, enabling progressively improving personalization and communication optimization over time while maintaining the phone number 310 as the stable anchor that ties all accumulated data to a persistent user identity.

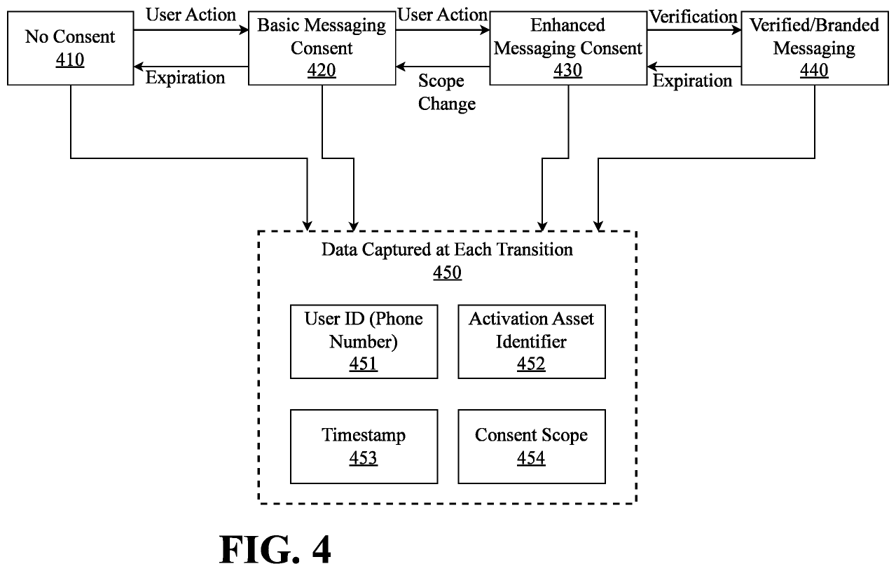

FIG. 4 is a state diagram illustrating a multi-state opt-in state machine, according to an embodiment. The diagram shows four distinct consent states and the transitions between them, demonstrating how the system models opt-in as a structured, graduated consent framework rather than a binary permission flag. This multi-state approach enables the system to manage different levels of messaging permissions with precision, to enforce protocol-specific eligibility requirements, and to maintain compliance with varying consent scopes as users progress through different engagement stages.

The state machine comprises four consent states: no consent 410, basic messaging consent 420, enhanced messaging consent 430, and verified/branded messaging 440. No consent 410 represents the initial state in which no messaging is permitted to the user, serving as the default state before any opt-in event has been captured. Basic messaging consent 420 represents a state in which SMS and MMS messaging is permitted, enabling standard text-based communications but not enhanced protocol features. Enhanced messaging consent 430 represents a state in which RCS messaging with rich features is permitted, enabling the use of rich cards, interactive buttons, branded sender identity, and rich media content. Verified/branded messaging 440 represents the highest consent level in which business-verified branded messaging capabilities are enabled, typically requiring completion of external verification processes that confirm business identity and authorization for branded communications.

The state machine supports bidirectional transitions between states, allowing both progression to higher consent levels and regression to lower consent levels based on various triggering events. This bidirectional capability is essential for maintaining accurate consent status over time as user preferences, authorization status, and external verification conditions change. Forward transitions from no consent 410 to basic messaging consent 420, from basic messaging consent 420 to enhanced messaging consent 430, and from enhanced messaging consent 430 to verified/branded messaging 440 may be triggered by user action, wherein the user actively interacts with an activation asset or explicitly grants additional permissions, or by verification processes, wherein external systems confirm authorization for higher-level messaging capabilities.

Backward transitions in the reverse direction may be triggered by multiple types of events that reduce the applicable consent level. Expiration events may cause transitions from basic messaging consent 420 back to no consent 410, or from enhanced messaging consent 430 back to basic messaging consent 420, or from verified/branded messaging 440 back to enhanced messaging consent 430, when time-limited consent periods conclude or when periodic reconfirmation requirements are not satisfied. Scope changes may trigger backward transitions when campaign parameters change in ways that invalidate previously granted permissions, or when consent that was granted for specific purposes or campaigns is no longer applicable to current interaction contexts. Loss of verification status may trigger transitions from verified/branded messaging 440 to lower states when external verification systems revoke business authorization or when verification credentials expire.

At each state transition, whether forward or backward, the system captures data 450 comprising multiple data elements that provide context and audit capability for the consent change. This comprehensive data capture ensures that the system maintains a complete record of how and why consent states have evolved over time, enabling compliance verification, dispute resolution, and optimization of consent management strategies. The captured data includes user identifier 451, which comprises the phone number serving as the identity anchor and enabling the system to associate the consent state change with the correct persistent identity profile. The captured data further includes activation asset identifier 452, which identifies the specific digital activation asset, campaign, QR code, call-to-action button, or other triggering mechanism that initiated the consent state change, enabling attribution of consent events to specific marketing initiatives or user touchpoints.

The captured data further includes timestamp 453, which records the exact date and time of the state transition with sufficient precision to support audit requirements, compliance verification, and temporal analysis of consent patterns. The captured data further includes consent scope 454, which specifies the extent and limitations of the messaging permissions granted or revoked during the transition, including information about which protocols are authorized, which message types are permitted, what campaign contexts are covered, what duration applies to the consent, and any other restrictions or qualifications that define the boundaries of the granted permissions. This consent scope information is critical for ensuring that subsequent messaging operations remain within the bounds of user authorization and that the channel eligibility service can accurately determine which protocols and features may be used for communications with this identity.

This multi-state consent model enables the system to enforce graduated messaging eligibility based on precise consent status, to maintain a complete audit trail of consent changes over time, and to ensure that messaging protocol selection and feature enablement remain compliant with the user's current consent state as managed by the opt-in state manager. The state machine architecture allows consent status to evolve naturally as users engage more deeply with the system and as external conditions change, while preserving the ability to restrict permissions when authorization expires or when circumstances require reduced access. By capturing comprehensive contextual data at each transition, the system creates an auditable record that supports compliance with privacy regulations, enables analysis of consent patterns to optimize opt-in strategies, and provides the foundational data that the opt-in state manager uses to gate access to different messaging protocols and features throughout the user's engagement lifecycle.

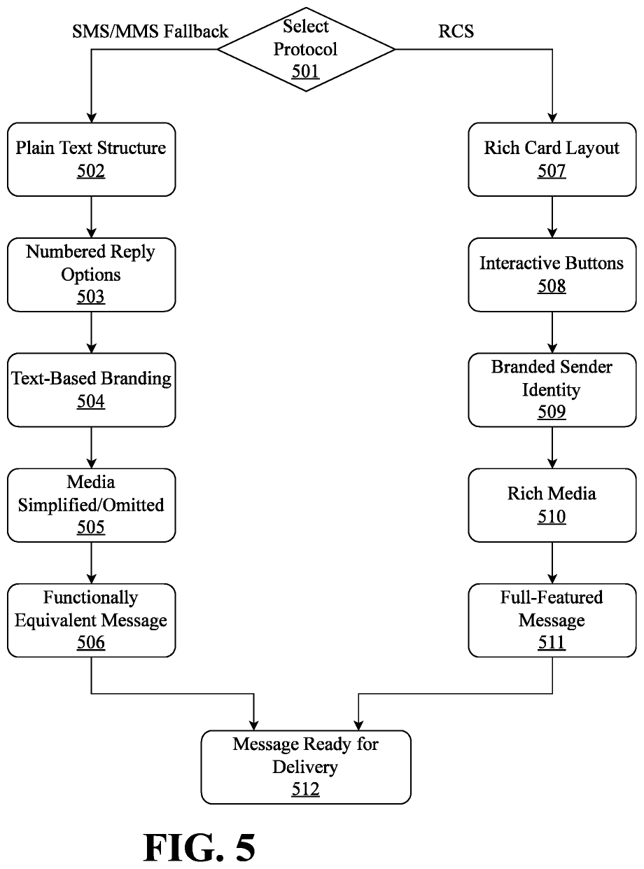

FIG. 5 is a flowchart diagram illustrating capability-aware message construction for dual protocols, according to an embodiment. The diagram shows how the system adapts message formatting and features based on the selected messaging protocol while preserving the core interaction intent, and demonstrates the parallel construction paths that enable the same underlying interaction logic to be expressed through either rich RCS features or adapted SMS/MMS formatting depending on protocol availability and eligibility.

The process begins at step 501, where the system receives the protocol selection decision from the channel eligibility service. This protocol selection represents the output of the capability negotiation and eligibility determination processes described in previous figures, indicating whether RCS has been selected based on successful capability negotiation and opt-in authorization, or whether SMS or MMS has been selected as a fallback protocol due to capability limitations, consent restrictions, or other eligibility factors. The protocol selection decision determines which of two parallel message construction paths will be followed to format the message for delivery.

When RCS is the selected protocol, the system follows the RCS construction path beginning at step 507, where rich card layout formatting is applied to structure the message content in an engaging visual presentation. Rich card layout 507 enables the message to be presented with structured visual elements including headers, body text sections, images positioned within defined layout regions, and organized information hierarchies that enhance readability and user engagement compared to plain text formats. This rich layout capability leverages RCS protocol features to create messages that resemble interactive application interfaces rather than simple text messages, providing a more sophisticated and branded user experience.

At step 508, interactive buttons are added to the RCS message to enable user actions without requiring typed responses. Interactive buttons 508 allow users to select from predefined response options, trigger specific actions such as opening URLs or initiating calls, provide feedback or confirmations, or navigate through multi-step interaction flows, all through simple button taps rather than text entry. These interactive elements reduce friction in user engagement, eliminate ambiguity in user responses by providing structured options rather than free-form text, and enable more complex interaction patterns that guide users through intended engagement sequences.

At step 509, branded sender identity is applied to the RCS message to display verified business information and enhance trust. Branded sender identity 509 shows the business name, logo, and verification badge within the message interface, indicates to the user that the message originates from a verified business entity rather than an unknown sender, and reinforces brand recognition and legitimacy through consistent visual identity presentation. This branding capability is particularly valuable for business-to-consumer communications where establishing sender authenticity and trustworthiness is critical to user engagement and conversion.

At step 510, rich media content is incorporated into the RCS message to enhance engagement through visual and multimedia elements. Rich media 510 may include high-resolution images that showcase products or convey visual information, video content that demonstrates features or tells stories, audio elements for voice messages or sound effects, interactive carousels that allow users to browse multiple items, and other multimedia content types supported by the RCS protocol. This rich media capability transforms the message from a text-based communication into a multimedia experience that can convey information more effectively and engage users more deeply than text alone.

The RCS construction path concludes at step 511, where the full-featured message is completed with all available RCS capabilities integrated into a cohesive, interactive, branded, and multimedia-rich communication that leverages the enhanced features of the RCS protocol to deliver an optimal user experience. This full-featured message represents the highest-quality output that the system can produce when technical capabilities and consent permissions align to enable enhanced messaging.

When SMS or MMS is the selected protocol due to RCS being unavailable or ineligible, the system follows the SMS/MMS fallback construction path beginning at step 502, where plain text structure is applied to format the message content in a linear text format compatible with SMS and MMS protocols. Plain text structure 502 converts any visual layout elements from the original message design into sequential text content, organizes information hierarchically using text formatting techniques such as line breaks and spacing, and presents content in a format that can be rendered in standard text messaging interfaces without requiring rich layout capabilities. This conversion ensures that the message content remains accessible and comprehensible even when rich formatting is unavailable.

At step 503, numbered reply options are created to replace interactive buttons with text-based alternatives that preserve interaction functionality. Numbered reply options 503 present user choices as a list with numeric identifiers such as “Reply 1 for Option A, 2 for Option B,” instruct users to respond with the number corresponding to their selection, and enable the system to interpret numeric text responses as equivalent to button selections from the RCS version. This adaptation maintains the structured interaction pattern and eliminates ambiguity in user responses, even though the interface mechanism changes from interactive buttons to text-based instructions.

At step 504, text-based branding is applied to preserve sender identification and business identity within the constraints of SMS and MMS protocols. Text-based branding 504 includes the business name in the message content or sender identification field, may incorporate text-based representations of branding elements such as taglines or identifiers, and maintains consistent messaging tone and language that reinforces brand identity even without visual logos or verification badges. This text-based approach ensures that users can identify the message sender and recognize the business origin, even though the visual branding elements available in RCS are not supported.

At step 505, media is simplified or omitted to adapt to the limited multimedia capabilities of SMS and MMS protocols. Media simplified or omitted 505 may involve converting images to text descriptions when visual content is essential to message understanding, including MMS image attachments when the fallback protocol is MMS rather than SMS and when critical visual information must be conveyed, or omitting media entirely when it serves decorative rather than informational purposes and when text content alone suffices to convey the intended message. This media adaptation ensures that the message can be delivered through protocols with limited or no multimedia support while preserving the essential informational content.

The SMS/MMS construction path concludes at step 506, where the functionally equivalent message is completed with all necessary adaptations applied to ensure that the core interaction intent is preserved despite protocol limitations. Functionally equivalent message 506 may lack the visual sophistication, interactivity, and multimedia richness of the RCS version, but delivers the same essential information, enables the same user actions through adapted mechanisms, and achieves the same interaction objectives within the constraints of SMS and MMS protocols. This functional equivalence ensures that users receive valuable and actionable communications regardless of their device or protocol capabilities.

Both construction paths converge at step 512, where the message ready for delivery is produced in the appropriate format for the selected protocol. Message ready for delivery 512 represents the final formatted message that will be transmitted to the messaging gateway for delivery, complete with all protocol-specific formatting applied, all features adapted to available capabilities, and all content structured for optimal rendering in the target messaging environment. The message is accompanied by metadata including the selected protocol, capability constraints that define which features are active, session identifiers for continuity tracking, and delivery instructions that specify how the message should be transmitted.

This dual-path construction approach enables the system to maintain consistent interaction logic and message intent across different protocol capabilities, to automatically adapt message formatting based on available features without requiring separate message authoring for each protocol, and to ensure that users receive high-quality communications optimized for their specific device and protocol capabilities while preserving functional equivalence across all delivery scenarios. The capability-aware message constructor applies these adaptations transparently based on the protocol selection output from the channel eligibility service, ensuring that message construction is always aligned with technical feasibility and consent permissions.

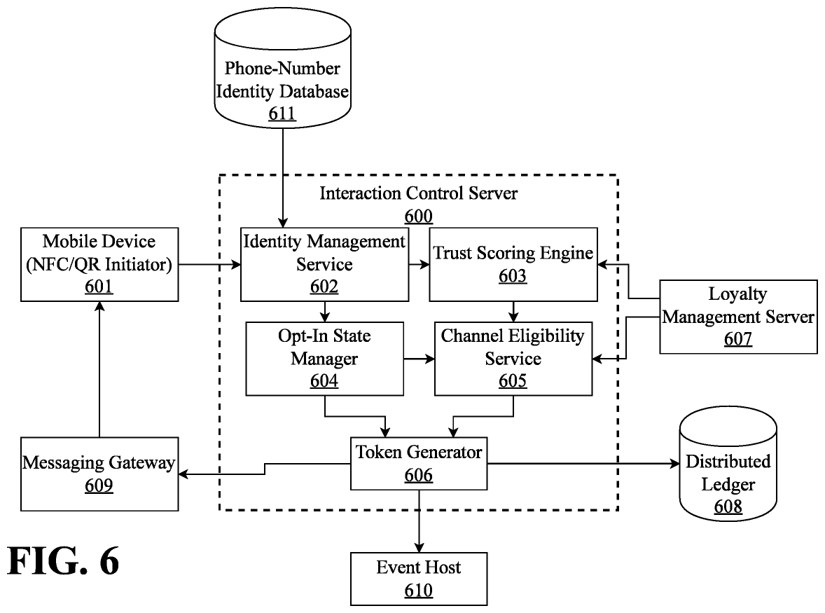

FIG. 6 is a block diagram illustrating an exemplary system architecture for an identity-weighted token generation system 600, according to an embodiment. The system 600 extends a dynamic-link verification platform by introducing persistent phone-number-anchored identity as a determinative input to access token generation, such that the parameters of a generated token reflect the accumulated verification history and trust context of the user rather than treating each verification event as an isolated transaction.

According to the embodiment, a mobile device 601, such as a smartphone or other NFC-capable computing device, serves as the point of user interaction with the system 600. The mobile device 601 interacts with a near-field communication beacon or quick-response code initiator, the interaction causing an auto-populated text message comprising a payload and initiator identifier to be transmitted to the system 600. The mobile device 601 additionally receives the generated access token from the system 600 upon successful identity-weighted verification, as further described herein.

The system 600 comprises an interaction control server 600 within which several constituent services operate in coordination. The interaction control server 600 is depicted with a dashed boundary indicating the logical grouping of its internal services. The interaction control server 600 is communicatively coupled to the mobile device 601, a messaging gateway 609, a phone-number identity database 611, a loyalty management server 607, a distributed ledger 608, and an event host 610, each of which is described in further detail below.

An identity management service 602 operates within the interaction control server 600 and is configured to maintain persistent user identity profiles anchored to phone numbers as primary identifiers. Upon receipt of an interaction from the mobile device 601, the identity management service 602 queries the phone-number identity database 611 using the phone number associated with the interaction as the primary key, retrieving accumulated contextual data comprising prior interaction history, device associations, communication preferences, opt-in records, and engagement patterns if an existing profile is found, or initializing a new identity record if no prior profile exists. The identity management service 602 provides the retrieved or initialized identity data to the trust scoring engine 603 and the opt-in state manager 604 for further processing.

The phone-number identity database 611 is communicatively coupled to the identity management service 602 and serves as the persistent data store for phone-number-anchored identity profiles. The phone-number identity database 611 stores accumulated contextual intelligence associated with each identity, including confidence indicators, behavioral observations, device associations, and historical opt-in state transitions, and is updated by the identity management service 602 upon each interaction to reflect newly acquired contextual data.

A trust scoring engine 603 operates within the interaction control server 600 and is configured to receive accumulated identity data from the identity management service 602 and loyalty status information from the loyalty management server 607, and to compute an identity confidence score reflecting the depth and quality of the user's verified identity history. The trust scoring engine 603 applies inference logic and behavioral analysis to the accumulated data to derive a confidence score that is used to weight the parameters of the access token to be generated. A user with no prior interaction history will receive a lower confidence score resulting in a more restrictive token configuration, while a user with a rich and consistent verification history will receive a higher confidence score enabling a more privileged token configuration. The trust scoring engine 603 provides the computed confidence score to the token generator 606 as a determinative input to token parameter selection.

An opt-in state manager 604 operates within the interaction control server 600 and is configured to evaluate and maintain the opt-in state associated with the interacting user. The opt-in state manager 604 receives identity data from the identity management service 602 and determines the current opt-in state governing messaging eligibility and access privilege level. The opt-in state manager 604 provides opt-in state information to both the channel eligibility service 605 and the token generator 606, such that the generated token reflects the user's consent scope in addition to their identity confidence level.

A channel eligibility service 605 operates within the interaction control server 600 and is configured to determine the appropriate messaging protocol for token delivery based on opt-in state information received from the opt-in state manager 604 and capability information negotiated with external platform services. The channel eligibility service 605 provides protocol selection parameters to the token generator 606 such that the token may be formatted and delivered appropriately for the selected channel.

The token generator 606 operates within the interaction control server 600 and is configured to receive the identity confidence score from the trust scoring engine 603, opt-in state parameters from the opt-in state manager 604, and channel selection parameters from the channel eligibility service 605, and to generate an identity-weighted access token whose entropy, privilege level, and format reflect the combined inputs of these services. The parameters of the generated token are not fixed by an access rule alone but are dynamically adjusted based on the identity confidence score such that the token encodes a trust-differentiated entitlement. Upon generating the token, the token generator 606 transmits the token to the messaging gateway 609 for delivery to the mobile device 601, writes an enriched entry to the distributed ledger 608, and sends a tiered status notification to the event host 610.

The loyalty management server 607 is communicatively coupled to the trust scoring engine 603 and is configured to provide loyalty status information associated with the user's phone-number-anchored identity, including loyalty tier, reward status, and engagement value indicators. The loyalty management server 607 enables the trust scoring engine 603 to incorporate loyalty context into the confidence score computation, and may additionally influence the privilege parameters applied by the token generator 606 to reflect loyalty-based access entitlements such as expedited entry or tier-based physical access zones.

The messaging gateway 609 is communicatively coupled to the token generator 606 and the mobile device 601 and is configured to receive the generated access token from the token generator 606 and deliver it to the mobile device 601 using the messaging protocol selected by the channel eligibility service 605. The messaging gateway 609 supports multiple messaging protocols including Rich Communication Services (RCS), Short Message Service (SMS), and Multimedia Messaging Service (MMS), and selects among these based on device capability and opt-in state as determined by the channel eligibility service 605.

The distributed ledger 608 is communicatively coupled to the token generator 606 and is configured to receive and store an enriched ledger entry upon each token issuance. The ledger entry recorded by the system 600 comprises not only the generated token but additionally the identity confidence score at the time of issuance, the messaging protocol used for delivery, the opt-in state at the time of issuance, and the loyalty tier of the user, creating an auditable trust evolution record that may be referenced by the event host 610 and the identity management service 602 in subsequent interactions to inform adaptive access policy decisions.

The event host 610 is communicatively coupled to the token generator 606 and is configured to receive a tiered status notification upon token generation, wherein the notification reflects the access privilege level encoded in the generated token rather than a binary verification confirmation. The event host 610 provides access to a controlled physical location in accordance with the privilege level indicated by the notification and upon activation of the access token by the mobile device 601.

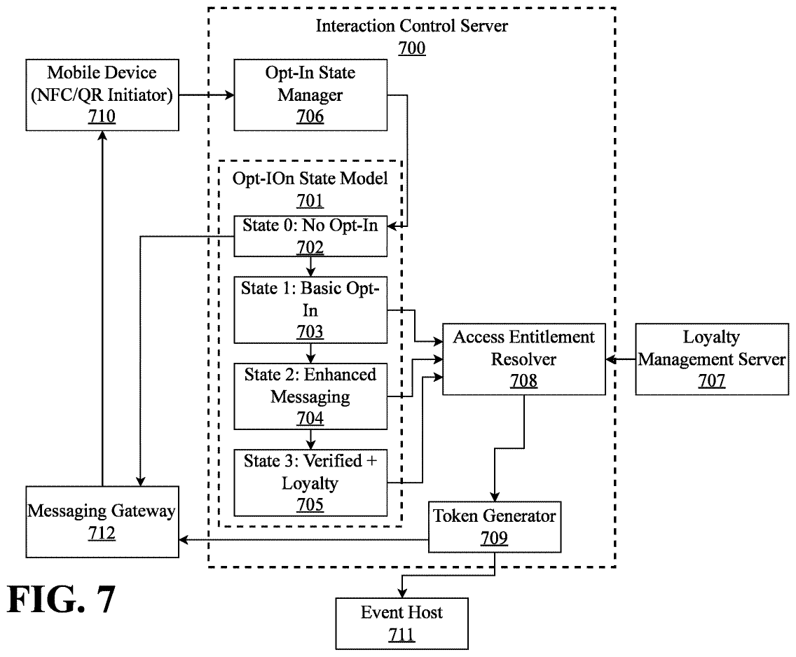

FIG. 7 is a block diagram illustrating an exemplary system architecture for a consent-gated access level system, according to an embodiment. The system 700 introduces a multi-state opt-in model as the governing structure for physical access entitlement determination, wherein the level of access privilege assigned to a user is a function of their accumulated consent state rather than a binary permitted or denied determination. The system 700 comprises an interaction control server 700, depicted with a dashed boundary indicating the logical grouping of its internal services, which is communicatively coupled to a mobile device 710, a messaging gateway 712, a loyalty management server 707, and an event host 711.

According to the embodiment, a mobile device 710, such as a smartphone or other NFC-capable computing device, serves as the point of user interaction with the system 700. The mobile device 710 interacts with a near-field communication beacon or quick-response code initiator, the interaction causing an opt-in event to be captured by the interaction control server 700 comprising the user's phone number, activation asset identifier, and consent scope parameters. The mobile device 710 additionally receives the generated access token from the messaging gateway 712 upon successful entitlement determination, as further described herein.

The interaction control server 700 comprises an opt-in state manager 706, an opt-in state model 701, an access entitlement resolver 708, and a token generator 709, each of which operates in coordination to evaluate the user's consent state and produce a correspondingly privileged access token.

The opt-in state manager 706 operates within the interaction control server 700 and is configured to capture opt-in events triggered by user interactions with digital activation assets, to maintain opt-in state information using a state-based model rather than binary permission flags, and to evaluate the current opt-in state of a user upon each interaction. The opt-in state manager 706 enforces state transitions in response to user actions, elapsed time, campaign context changes, or external verification processes, and provides the current opt-in state to the access entitlement resolver 708 as a primary input to access privilege determination.

The opt-in state model 701 is depicted within the interaction control server 700 as an inner dashed grouping comprising four discrete states that define the range of messaging eligibility and access entitlement levels available within the system 700. State 0 702 represents the absence of any opt-in, wherein no messaging is permitted and no access token is generated. Users in State 0 702 are routed directly to the messaging gateway 712 with a denial or deferral response without proceeding to the access entitlement resolver 708 or token generator 709. State 1 703 represents a basic opt-in level, wherein standard messaging is permitted and a standard access token with basic entitlement parameters is eligible for generation. State 2 704 represents an enhanced messaging opt-in level, wherein Rich Communication Services delivery is permitted and an enhanced access token reflecting elevated entitlement is eligible for generation. State 3 705 represents a verified identity and loyalty-confirmed opt-in level, wherein the highest tier of access entitlement is available, including expedited entry, tier-based physical access zones, and loyalty-augmented access privileges as further described with respect to the loyalty management server 707.

The loyalty management server 707 is communicatively coupled to the access entitlement resolver 708 and is configured to provide loyalty status information associated with the user's phone-number-anchored identity, including loyalty tier, reward status, and engagement value indicators. The loyalty management server 707 operates as a secondary input to the access entitlement resolver 708, supplementing the opt-in state with loyalty context such that users in State 3 705 may receive dynamically adjusted access privileges reflecting their loyalty standing in addition to their verified identity status.

The access entitlement resolver 708 operates within the interaction control server 700 and is configured to receive the current opt-in state from the opt-in state manager 706 and loyalty status information from the loyalty management server 707, and to produce a unified access entitlement parameter set that is transmitted to the token generator 709. The access entitlement resolver 708 applies prioritization logic that maps each opt-in state to a corresponding access privilege tier, with the loyalty management server 707 operating as a modifier on top of the opt-in state evaluation for users in State 3 705. Users in State 0 702 do not reach the access entitlement resolver 708, as the opt-in state manager 706 routes such interactions directly to a denial or deferral response prior to entitlement resolution.

The token generator 709 operates within the interaction control server 700 and is configured to receive the access entitlement parameter set from the access entitlement resolver 708 and to generate an access token whose privilege level, entropy, and format reflect the assigned entitlement tier. The token generator 709 transmits the generated token to the messaging gateway 712 for delivery to the mobile device 710 and sends a tiered status notification to the event host 711 indicating the privilege level of the issued token.

The messaging gateway 712 is communicatively coupled to the token generator 709 and the mobile device 710 and is configured to receive the generated access token from the token generator 709 and deliver it to the mobile device 710 using a messaging protocol appropriate to the user's opt-in state and device capabilities. For users in State 2 704 or State 3 705, the messaging gateway 712 may deliver the token via Rich Communication Services where device capability and carrier support permit, while users in State 1 703 receive token delivery via Short Message Service or Multimedia Messaging Service. Users in State 0 702 receive no token delivery, as the interaction is terminated prior to token generation.

The event host 711 is communicatively coupled to the token generator 709 and is configured to receive a tiered status notification upon token generation, wherein the notification reflects the access privilege level encoded in the generated token. The event host 711 provides access to a controlled physical location in accordance with the privilege level indicated by the notification and upon activation of the access token by the mobile device 710, such that different users may be granted access to different physical zones, entry lanes, or privilege tiers based on their consent state and loyalty standing as determined by the system 700.

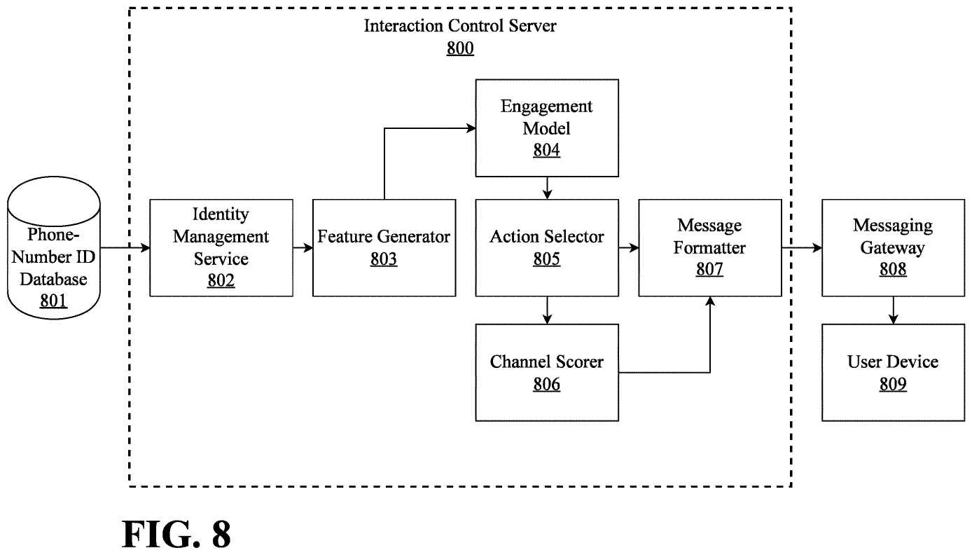

FIG. 8 is a block diagram illustrating an exemplary system architecture for an engagement decision system with predictive model flow, according to an embodiment. The diagram shows how machine learning-based predictive intelligence is integrated into the messaging platform to determine optimal engagement actions and communication channels for each user based on accumulated identity data and real-time inference. The system transforms reactive messaging into proactive, data-driven engagement by applying trained models that learn from historical outcomes to predict which actions and channels will maximize user engagement and conversion probability.

According to the embodiment, the system comprises a phone-number identity database 801, which stores persistent user identity profiles anchored to phone numbers as primary identifiers. The phone-number identity database 801 contains accumulated contextual intelligence including interaction history spanning multiple campaigns and sessions, device associations linking phone numbers to specific hardware and platforms used over time, communication preferences derived from observed protocol usage patterns, opt-in records documenting consent state evolution, engagement patterns showing response rates and interaction timing, behavioral observations capturing user actions across prior engagements, loyalty program status and reward tier information, purchase or transaction history indicating commercial intent, and inferred user preferences developed through analysis of accumulated interaction data. This database serves as the knowledge repository that enables the system to treat each engagement decision as an informed prediction rather than a generic broadcast.

The system further comprises an interaction control server 800, depicted with a dashed boundary indicating the logical grouping of its internal services. The interaction control server 800 is communicatively coupled to the phone-number identity database 801, messaging gateway 808, and user device 809, and coordinates the flow of data through the predictive engagement pipeline from identity retrieval through model inference to message delivery.

An identity management service 802 operates within the interaction control server 800 and is configured to retrieve user identity profiles from the phone-number identity database 801 upon receipt of an interaction event. When a user interacts with a digital activation asset, campaign trigger, or system touchpoint, the identity management service 802 queries the phone-number identity database 801 using the phone number associated with the interaction as the primary key, retrieving the complete accumulated profile data that documents this user's engagement history with the system. The identity management service 802 merges new contextual data from the current interaction with the existing profile, updating timestamps, incrementing engagement counters, recording the current campaign context, and capturing any new device or behavioral signals. This merged profile, containing both historical intelligence and current context, is then forwarded to the feature generator 803 for transformation into model-compatible inputs.

A feature generator 803 operates within the interaction control server 800 and is configured to receive identity profile data from the identity management service 802 and transform it into a structured feature representation suitable for machine learning model consumption. The feature generator 803 applies feature engineering logic to extract meaningful signals from raw profile data, assembling features including prior response rates for specific channels calculated as ratios of responses to deliveries across SMS, RCS, and email, historical interaction frequency measured as engagements per time period to identify highly active versus dormant users, device capability indicators derived from platform information and messaging client attributes, time-of-day engagement likelihood computed from timestamps of prior successful interactions to identify when this user is most responsive, campaign context parameters encoding the current product category or promotional theme, geographic location signals indicating regional patterns or proximity to physical locations, loyalty status indicators reflecting tier membership and reward point balances, prior purchase behavior documenting transaction history and average order values, and message open and click history tracking engagement depth beyond simple delivery confirmation. The feature generator 803 produces a structured feature vector that encodes the user's complete engagement context and behavioral patterns in a format optimized for rapid model inference.

An engagement model 804 operates within the interaction control server 800 and is configured to receive the feature vector from the feature generator 803 and apply trained machine learning algorithms to predict optimal engagement strategies for this specific user at this specific moment. The engagement model 804 may be implemented using gradient-boosted decision trees that learn hierarchical decision rules from training data, neural networks that capture complex nonlinear relationships between features and outcomes, reinforcement learning models that optimize for long-term engagement value rather than immediate response, or ensemble methods that combine multiple model types to improve prediction robustness. The engagement model 804 processes the feature vector through its trained parameters, computing predicted engagement probabilities for multiple candidate actions such as product offer presentation, appointment scheduling, information request, agent escalation, or loyalty incentive delivery. The model additionally generates channel-specific engagement scores predicting how likely the user is to respond if contacted via RCS with rich interactive features, via SMS with text-based simplicity, via MMS with visual content, or via email with detailed formatting. The engagement model 804 serves as the central intelligence component that transforms accumulated identity data and current context into actionable predictions about how to engage this user most effectively based on patterns learned from thousands or millions of prior interactions across the user base.

An action selector 805 operates within the interaction control server 800 and is configured to receive predicted engagement probabilities from the engagement model 804 and determine the next best engagement action for the user based on which action received the highest predicted engagement score. The action selector 805 evaluates multiple possible actions maintained in an action catalog, which may include presenting targeted product offers selected based on purchase history and browsing behavior, sending appointment scheduling links with embedded calendar integration for service-based engagements, requesting additional qualification information to assess purchase readiness or product fit, routing to live agents when high-value conversion opportunity is detected, delivering loyalty incentives such as exclusive discounts or early access offers, providing educational content about product features or usage scenarios, or initiating transaction workflows for users exhibiting strong purchase intent signals. The action selector 805 applies business rules and constraints on top of model predictions, ensuring that selected actions respect campaign budgets, inventory availability, agent capacity, and business policy requirements while still optimizing for predicted engagement effectiveness. The selected action, along with its predicted engagement score and any associated parameters such as specific products to feature or scheduling time windows to offer, is transmitted to the message formatter 807 for content generation.

A channel scorer 806 operates within the interaction control server 800 in parallel with the action selector 805 and is configured to receive channel predictions from the engagement model 804 and assign scores to available communication channels including Rich Communication Services, Short Message Service, Multimedia Messaging Service, and email. Unlike traditional systems that select channels based solely on technical capability availability, the channel scorer 806 evaluates predicted engagement effectiveness for each channel by analyzing how this specific user has historically responded to messages delivered via different protocols. The channel scorer 806 examines model outputs indicating, for example, that this user shows 0.61 predicted engagement probability for RCS messages with interactive buttons and rich cards, 0.42 predicted engagement probability for plain SMS messages, 0.28 predicted engagement probability for MMS messages with images, and 0.17 predicted engagement probability for email communications. The channel scorer 806 then applies capability and consent constraints, filtering out channels that are technically unavailable due to device limitations or carrier support gaps, or channels that are prohibited by the user's current opt-in state as maintained in the multi-state consent model. From the remaining eligible channels, the channel scorer 806 selects the protocol with the highest predicted engagement score, implementing an optimization strategy that maximizes expected response probability while respecting technical and regulatory constraints. This channel selection decision, along with capability constraints defining which features are available within the selected protocol, is transmitted to the message formatter 807 for protocol-aware content generation.

A message formatter 807 operates within the interaction control server 800 and is configured to receive the selected action from the action selector 805 and the selected channel from the channel scorer 806, and to construct an engagement message that implements the chosen action using formatting appropriate to the chosen channel. The message formatter 807 retrieves message templates or generation logic associated with the selected action, populates dynamic content fields with user-specific personalization such as name, product recommendations, pricing, or scheduling availability, and applies protocol-specific formatting rules to ensure the message renders correctly on the target channel. For RCS delivery, the message formatter 807 generates rich card layouts with structured information hierarchy, embeds interactive buttons that enable single-tap responses or navigation, incorporates branded sender identity elements including business name and logo, and includes rich media such as product images or demonstration videos where appropriate to the action intent. For SMS delivery when RCS is unavailable or scores lower, the message formatter 807 converts rich layouts to plain text descriptions maintaining information completeness within SMS length constraints, replaces interactive buttons with text instructions such as “Reply 1 to schedule, 2 to learn more, 3 to speak with an agent,” preserves branding through text-based business identification, and strips or describes media content that cannot be delivered via text-only protocol. The message formatter 807 produces a complete message ready for transmission, encoded with session identifiers for tracking and attribution, formatted for optimal rendering on the target protocol, and containing all interactive elements or response mechanisms needed to execute the selected engagement action.

The messaging gateway 808 is communicatively coupled to the interaction control server 800 and is configured to receive the formatted engagement message from the message formatter 807 and deliver it to the user device 809 using the selected messaging protocol. The messaging gateway 808 interfaces with carrier messaging networks for SMS and MMS delivery, RCS platform services and business messaging providers for RCS delivery, and email servers for email delivery, managing the protocol-specific handshakes, authentication, and transmission requirements for each channel. The messaging gateway 808 monitors delivery status, capturing confirmation when messages successfully reach the user device, detecting failures when delivery is blocked by network issues or capability problems, and forwarding delivery receipts and user responses back to the interaction control server 800 for outcome tracking and model training.

The user device 809 is communicatively coupled to the messaging gateway 808 and is configured to receive the engagement message delivered via the selected channel, to display the message content to the user with formatting appropriate to the device's messaging application and screen size, and to enable user interaction through tapping buttons, clicking links, sending replies, or taking other actions prompted by the message. User responses or interactions are transmitted back through the messaging gateway 808 to the interaction control server 800, where they are processed by the identity management service 802 for incorporation into the user's profile, recorded as engagement outcomes for continuous learning, and evaluated to determine appropriate follow-up actions in multi-step engagement sequences. This bidirectional communication flow creates a closed loop where each engagement informs the next, enabling the engagement model 804 to refine its predictions over time as it observes which actions and channels actually produce engagement for different user segments and contexts.

The architecture illustrated in FIG. 8 demonstrates how predictive modeling transforms the messaging platform from a simple delivery mechanism into an intelligent engagement system that learns from experience, adapts to individual user preferences, and continuously optimizes its approach to maximize response rates and conversion outcomes. By layering machine learning inference between identity retrieval and message delivery, the system enables sophisticated personalization at scale without requiring manual configuration or rules-based decision trees that quickly become unmaintainable as user populations and campaign complexity grow.

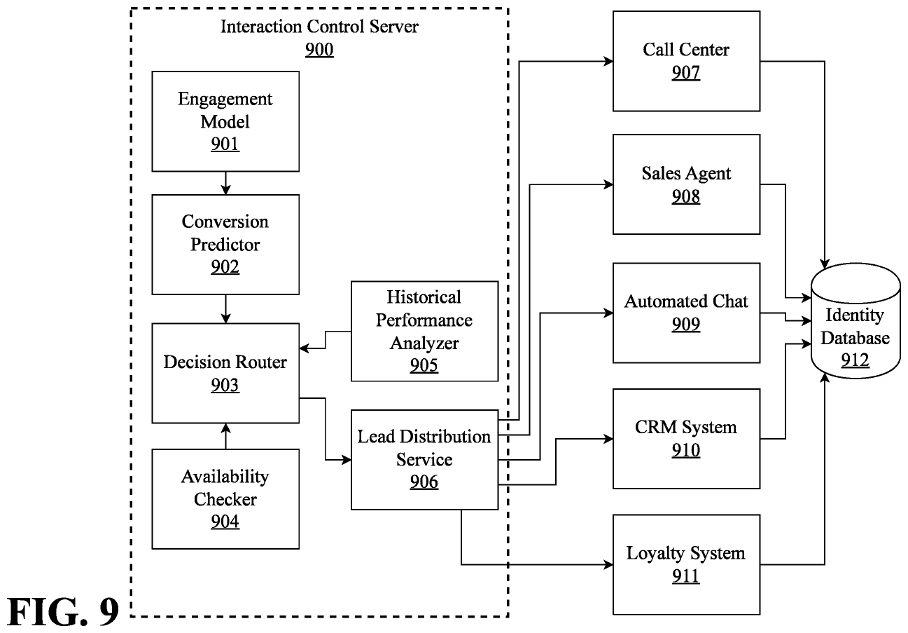

FIG. 9 is a block diagram illustrating an exemplary system architecture for a lead routing system with conversion-optimized intelligent distribution, according to an embodiment. The diagram shows how predicted conversion probabilities, agent availability, historical performance data, and user identity context are combined to determine optimal routing destinations for qualified leads, enabling the system to direct each engagement to the channel or resource most likely to produce successful conversion outcomes.

According to the embodiment, the system comprises an interaction control server 900, depicted with a dashed boundary indicating the logical grouping of its internal routing intelligence services. The interaction control server 900 is communicatively coupled to multiple downstream lead destinations including call center 907, sales agent 908, automated chat 909, customer relationship management system 910, and loyalty system 911, and to an identity database 912 that provides historical context for routing decisions.

An engagement model 901 operates within the interaction control server 900 and is configured to evaluate user interactions and produce initial engagement assessments that feed into the conversion prediction and routing pipeline. The engagement model 901 receives identity data and interaction signals, applies trained machine learning algorithms to assess user intent and engagement readiness, and generates preliminary classifications indicating whether the user represents a high-value conversion opportunity requiring immediate human attention, a moderate-value prospect suitable for automated nurturing, or an informational inquiry best served through self-service channels. The engagement model 901 produces engagement scores and user classifications that serve as inputs to the conversion predictor 902, enabling more sophisticated routing decisions than simple round-robin or availability-based assignment.

A conversion predictor 902 operates within the interaction control server 900 and is configured to receive engagement assessments from the engagement model 901 and compute predicted conversion probabilities for different routing destinations. The conversion predictor 902 applies trained models that analyze the user's identity profile including purchase history, prior interaction outcomes, engagement frequency, loyalty status, and demographic or behavioral attributes, combines this profile data with current interaction context such as the product category of interest, price point, campaign source, and time-of-day, and evaluates feature patterns that historically correlate with successful conversions when routed to specific destination types. For example, the conversion predictor 902 may determine that users exhibiting high purchase intent signals combined with prior positive experiences with human agents show 0.72 predicted conversion probability when routed to sales agent 908, 0.58 predicted conversion probability when routed to call center 907, 0.31 predicted conversion probability when routed to automated chat 909, and 0.19 predicted conversion probability when simply logged to customer relationship management system 910 for follow-up outreach. The conversion predictor 902 generates these probability estimates for each available routing destination, creating a scored ranking that informs optimal routing decisions while accounting for the specific characteristics and conversion drivers applicable to this user at this moment.

A decision router 903 operates within the interaction control server 900 and is configured to receive predicted conversion probabilities from the conversion predictor 902, availability status from the availability checker 904, and performance metrics from the historical performance analyzer 905, and to determine the optimal routing destination by synthesizing these inputs into a unified routing decision. The decision router 903 applies multi-factor optimization logic that balances predicted conversion probability against resource availability, ensuring that high-value leads are not queued indefinitely waiting for busy resources when acceptable alternative destinations are immediately available. The decision router 903 incorporates business constraints such as maximum queue depths, service level agreements requiring response within specified timeframes, regional assignment rules that match users to agents based on geography or language, and priority tiers that may elevate certain user segments or campaign sources to front-of-queue status. The decision router 903 evaluates these factors in combination, implementing decisioning algorithms that might route a moderate-conversion-probability lead to an immediately available sales agent 908 rather than queueing a high-conversion-probability lead for a busy specialist when the conversion probability differential is small relative to the value of immediate engagement. The decision router 903 produces a routing decision specifying the target destination and any special handling instructions such as priority level or context information to present to the receiving resource.

An availability checker 904 operates within the interaction control server 900 and is configured to monitor real-time availability status of potential routing destinations including call center 907 agents, individual sales agents 908, automated chat 909 capacity, and integration endpoints for customer relationship management system 910 and loyalty system 911. The availability checker 904 queries agent management systems to determine how many call center 907 representatives are currently online, idle, or handling interactions, tracks individual sales agent 908 status through presence indicators showing available, busy, in meeting, or offline states, monitors automated chat 909 concurrent session counts against configured capacity limits, and verifies connectivity and responsiveness of API endpoints for customer relationship management system 910 and loyalty system 911. The availability checker 904 continuously updates availability status, detecting when agents log on or off, when call center 907 queues exceed threshold depths indicating saturation, when automated chat 909 resources become available after completing prior sessions, or when downstream systems experience degraded performance or outages. This real-time availability intelligence is provided to the decision router 903 to ensure routing decisions account for current resource constraints rather than directing leads to destinations unable to handle them promptly.

A historical performance analyzer 905 operates within the interaction control server 900 and is configured to retrieve and analyze historical routing outcomes from the identity database 912 to identify which destinations have historically produced the best conversion results for different user segments and interaction contexts. The historical performance analyzer 905 queries the identity database 912 for records documenting prior routing events, the destinations to which users were routed, the outcomes that resulted including conversions, abandonments, or ongoing nurture sequences, and the time-to-conversion or other performance metrics associated with each routing path. The historical performance analyzer 905 computes aggregate statistics such as conversion rates by destination type, average deal size by routing path, time-to-close by agent or team, and customer satisfaction scores by channel, and identifies patterns indicating that certain user characteristics such as high-value customer segments, specific product interests, or particular geographic regions show significantly better conversion outcomes when routed to specialized sales agents 908 versus generalist call center 907 representatives. The historical performance analyzer 905 provides these performance insights to the decision router 903, enabling routing logic to incorporate empirical evidence about which destinations are most effective for users matching the current interaction profile, creating a feedback loop where routing decisions improve continuously as more outcome data accumulates.

A lead distribution service 906 operates within the interaction control server 900 and is configured to receive routing decisions from the decision router 903 and execute the distribution of leads to selected destinations by formatting and transmitting lead data in protocols appropriate to each destination type. The lead distribution service 906 receives the routing decision specifying the target destination along with lead context including user identity, interaction history, product interests, predicted conversion probability, recommended handling approach, and session identifiers for attribution tracking. For routing to call center 907, the lead distribution service 906 formats the lead data according to call center queue management protocols, transmits the lead to the appropriate queue based on skills-based routing or campaign assignment, and includes screen pop data that agents will see upon accepting the lead such as customer name, phone number, interaction source, and recommended talking points. For routing to sales agent 908, the lead distribution service 906 delivers lead notifications through agent desktop interfaces, mobile applications, or email alerts depending on configured preferences, formats lead details in CRM-compatible structures if the agent works within embedded CRM tools, and sets priority flags or expiration timers to ensure timely follow-up. For routing to automated chat 909, the lead distribution service 906 initiates chat sessions by invoking chatbot platform APIs, passes context variables that enable the automated system to personalize greetings and initial responses based on known user information, and establishes session continuity mechanisms that allow graceful escalation to human agents if the automated chat cannot resolve the user's needs. For routing to customer relationship management system 910, the lead distribution service 906 creates or updates lead records through CRM APIs, populates standard and custom fields with captured interaction data, assigns leads to appropriate sales territories or account owners based on routing rules, and triggers automated workflows such as email sequences or task creation for delayed follow-up. For routing to loyalty system 911, the lead distribution service 906 logs engagement events that may qualify for loyalty point accrual, updates member profiles with interaction history, and may trigger loyalty-specific communications such as tier upgrade notifications or exclusive offer delivery.

The call center 907 is communicatively coupled to the lead distribution service 906 and is configured to receive routed leads through queue management systems, to present lead context to available agents through screen pop or integrated desktop interfaces, to enable agents to engage users through voice calls, SMS messaging, or omnichannel communication, and to report interaction outcomes back to the interaction control server 900 for recording in the identity database 912. The sales agent 908 is communicatively coupled to the lead distribution service 906 and is configured to receive lead notifications through preferred channels, to access full lead context and history, to conduct personalized outreach optimized for high-value conversion opportunities, and to log interaction results including successful conversions, ongoing negotiations, or qualified-out determinations back to the system. The automated chat 909 is communicatively coupled to the lead distribution service 906 and is configured to receive lead routing triggers with context variables, to initiate conversational interactions using natural language processing and predefined dialog flows, to handle routine inquiries and information provision without human involvement, to escalate to human resources when user needs exceed automated capabilities, and to record chat transcripts and outcomes for continuous improvement of chat automation logic.

The customer relationship management system 910 is communicatively coupled to the lead distribution service 906 and is configured to receive lead data through API integration, to create or update lead and contact records with comprehensive interaction history, to assign leads to sales territories or account owners based on routing rules and workload balancing, to trigger automated nurture workflows such as email drip campaigns or task assignments for follow-up outreach, and to serve as the system of record for opportunity tracking, pipeline management, and conversion attribution. The loyalty system 911 is communicatively coupled to the lead distribution service 906 and is configured to receive engagement event data for loyalty point accrual or tier status updates, to identify opportunities for loyalty-driven engagement such as exclusive offers or early access to new products, to track member engagement across campaigns and channels, and to provide loyalty status information back to the routing logic for use in prioritization decisions that may preferentially route high-tier members to premium service channels.

The identity database 912 is communicatively coupled to the historical performance analyzer 905 and to all downstream destinations 907-911, and is configured to store comprehensive records of routing events, lead distributions, agent assignments, interaction outcomes, conversion results, and performance metrics that enable continuous improvement of routing intelligence. The identity database 912 receives outcome data from call center 907 documenting call results and customer satisfaction scores, from sales agent 908 reporting conversion outcomes and deal values, from automated chat 909 logging session transcripts and resolution status, from customer relationship management system 910 providing opportunity progression and closed-won revenue, and from loyalty system 911 contributing engagement value and member lifetime metrics. This accumulated outcome data flows back to the historical performance analyzer 905 for pattern analysis and routing optimization, and is also accessible to the conversion predictor 902 for model training and refinement, creating a continuous learning cycle where routing decisions become progressively more accurate as the system observes which routing paths produce the best conversion outcomes for different user profiles and interaction contexts.

The architecture illustrated in FIG. 9 demonstrates how intelligent lead routing transforms engagement distribution from simple availability-based assignment into a sophisticated optimization system that predicts conversion probability, balances resource constraints, learns from historical performance patterns, and continuously adapts routing logic to maximize conversion outcomes while respecting operational constraints and service level requirements. By combining predictive modeling with real-time availability monitoring and empirical performance analysis, the system ensures that each qualified lead is directed to the destination offering the highest probability of successful conversion given current conditions and accumulated intelligence about what routing strategies work best for different user segments.

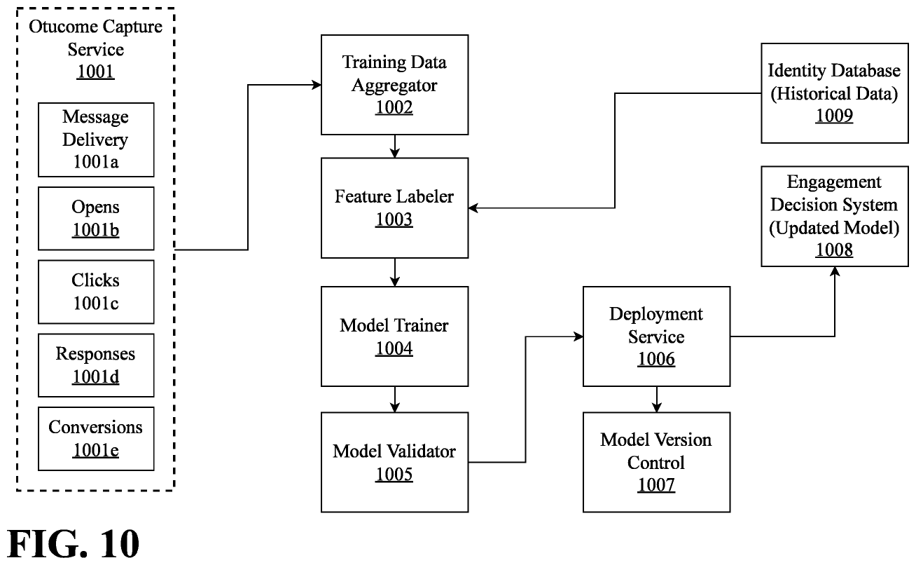

FIG. 10 is a block diagram illustrating an exemplary system architecture for a continuous learning and model training pipeline that enables the engagement system to improve its predictive accuracy over time by capturing interaction outcomes, aggregating training data, updating machine learning models, and deploying refined models back into production. The diagram shows how the system closes the feedback loop between engagement actions and observed results, transforming outcome data into improved predictions that progressively enhance engagement effectiveness and conversion rates.

According to the embodiment, the system comprises an outcome capture service 1001, which is configured to monitor and record engagement results across multiple interaction types and outcome categories. The outcome capture service 1001 receives signals from various sources within the messaging and engagement infrastructure, capturing message delivery 1001a events that confirm whether messages successfully reached user devices or encountered delivery failures, opens 1001b events indicating when users viewed delivered messages as reported through read receipts or tracking pixels, clicks 1001c events documenting when users interacted with links, buttons, or other actionable elements embedded in messages, responses 1001d events capturing user replies, form submissions, or other direct engagement actions, and conversions 1001e events recording completed transactions, scheduled appointments, qualified leads, or other outcomes representing successful achievement of engagement objectives. The outcome capture service 1001 timestamps each captured event, associates it with the original message delivery using session identifiers and user identity anchors, and records contextual metadata such as the engagement action that was selected, the communication channel used for delivery, the time elapsed between delivery and outcome, and any intermediate interactions that occurred in the engagement sequence. This comprehensive outcome capture creates the ground truth dataset that enables supervised learning, allowing models to learn which combinations of user characteristics, engagement actions, and channel selections historically produced successful outcomes.

A training data aggregator 1002 operates downstream of the outcome capture service 1001 and is configured to receive captured outcome events and combine them with the original interaction context to create labeled training examples suitable for model learning. The training data aggregator 1002 retrieves the feature vectors that were generated for each engagement decision from feature generation logs or cached feature stores, links these feature vectors to the outcome events captured by the outcome capture service 1001 using session identifiers and timestamps, and constructs training records that pair input features describing the user's identity profile, interaction context, and engagement state with output labels indicating whether the engagement produced positive outcomes such as message opens, link clicks, responses, or conversions. The training data aggregator 1002 applies data quality filters to exclude incomplete records, obvious data errors, or outlier cases that might introduce noise into model training, implements sampling strategies to balance training data across different outcome classes ensuring that rare but valuable conversion events are not overwhelmed by common but less informative delivery events, and partitions aggregated data into training sets used for model parameter optimization, validation sets used for hyperparameter tuning and model selection, and test sets reserved for final performance evaluation on unseen data. The training data aggregator 1002 continuously accumulates new training examples as engagement outcomes are captured, maintaining rolling windows of recent data that reflect current user behavior patterns while retaining historical data that provides statistical power for learning robust patterns.

A feature labeler 1003 operates downstream of the training data aggregator 1002 and is configured to transform raw outcome events into structured labels and target variables that machine learning algorithms can optimize against during training. The feature labeler 1003 receives training data from the training data aggregator 1002 and applies labeling logic that may create binary labels indicating success or failure for classification tasks such as predicting whether a message will be opened, multi-class labels distinguishing between different outcome types for action selection tasks such as choosing between product offer, appointment scheduling, or agent routing, regression targets representing continuous values for conversion probability estimation or predicted revenue per engagement, or time-to-event labels for survival analysis models that predict when conversions are likely to occur. The feature labeler 1003 additionally retrieves historical data from the identity database 1009 to enrich training examples with longer-term behavioral context beyond what is captured in individual interaction events, incorporating features such as lifetime engagement history, prior conversion patterns, customer value tier, and historical channel preferences that improve model ability to personalize predictions for individual users. The feature labeler 1003 may also derive synthetic labels through techniques such as attributing partial credit to intermediate engagement steps along conversion paths, weighting training examples by business value to emphasize high-revenue outcomes, or implementing reinforcement learning reward functions that optimize for long-term customer lifetime value rather than immediate response rates.

A model trainer 1004 operates downstream of the feature labeler 1003 and is configured to receive labeled training data and execute machine learning training algorithms that optimize model parameters to maximize predictive accuracy on the training dataset. The model trainer 1004 implements training procedures appropriate to the model architecture selected for the engagement system, which may include gradient descent optimization for neural networks that iteratively adjusts connection weights to minimize prediction error on training examples, tree-building algorithms for gradient-boosted decision trees that sequentially add decision rules targeting residual prediction errors from prior trees, policy gradient methods for reinforcement learning models that optimize action selection to maximize expected cumulative reward, or ensemble training procedures that combine multiple model types to improve prediction robustness. The model trainer 1004 applies regularization techniques to prevent overfitting on training data such as L1 or L2 weight penalties, dropout that randomly deactivates network connections during training, or early stopping that halts training when validation performance plateaus. The model trainer 1004 logs training metrics including loss curves showing how prediction error decreases over training iterations, feature importance scores indicating which input features most strongly influence predictions, and model checkpoints capturing parameter states at various training stages to enable recovery if training diverges or performance degrades.

A model validator 1005 operates downstream of the model trainer 1004 and is configured to evaluate trained model performance on held-out validation and test datasets to ensure that learned patterns generalize to new data rather than merely memorizing training examples. The model validator 1005 receives candidate models from the model trainer 1004 and applies comprehensive evaluation protocols that measure prediction accuracy using metrics such as area under the ROC curve for binary classification, precision and recall at various decision thresholds, mean absolute error for regression targets, or ranking quality metrics for recommendation tasks. The model validator 1005 performs cross-validation by training multiple model variants on different data partitions and averaging their performance to obtain robust accuracy estimates, conducts A/B testing simulations that replay historical interaction data and compare conversion outcomes under current production models versus newly trained candidate models, and executes fairness audits that verify prediction quality remains consistent across user segments to detect potential bias in model behavior. The model validator 1005 implements acceptance criteria that candidate models must satisfy before deployment, requiring minimum performance thresholds on validation metrics, statistically significant improvement over current production models, acceptable computational efficiency for real-time inference, and stability across different evaluation periods indicating robustness to temporal distribution shifts. Only models satisfying all acceptance criteria are forwarded to the deployment service 1006 for production release.

A deployment service 1006 operates downstream of the model validator 1005 and is configured to transition validated models from training environments into production systems where they power real-time engagement decisions. The deployment service 1006 receives approved models from the model validator 1005 along with associated metadata including performance metrics, training data versions, hyperparameter configurations, and validation results. The deployment service 1006 packages trained models into deployable artifacts such as serialized model files in formats like ONNX or TensorFlow SavedModel, containerized inference services that encapsulate models with their runtime dependencies, or compiled model binaries optimized for low-latency prediction. The deployment service 1006 coordinates deployment to the engagement decision system 1008 using strategies such as canary releases that initially route small percentages of traffic to new models while monitoring for performance degradation, blue-green deployments that maintain parallel model versions and switch traffic atomically once validation succeeds, or gradual rollouts that progressively increase new model traffic while comparing outcomes against baseline models. The deployment service 1006 implements rollback capabilities enabling rapid reversion to prior model versions if deployed models exhibit unexpected behavior, performance regressions, or production issues not detected during offline validation.

A model version control 1007 operates alongside the deployment service 1006 and is configured to maintain comprehensive records of all trained models, their training configurations, performance characteristics, deployment history, and operational outcomes. The model version control 1007 creates versioned model artifacts with unique identifiers that enable precise tracking of which model version powered each engagement decision, stores model metadata including training dataset versions, feature engineering code versions, hyperparameter settings, and training metrics that enable reproducibility of model builds, maintains deployment logs documenting when each model version was released to production, what traffic percentage it served, and when it was superseded by newer versions, and tracks production performance metrics for deployed models showing how prediction accuracy, engagement rates, and conversion outcomes evolve over time as models serve real user traffic. The model version control 1007 enables auditing and debugging by linking specific engagement outcomes back to the model version that made the prediction, supports experimentation by maintaining multiple model variants that can be compared in live traffic, and provides governance for model lifecycle management ensuring that only approved, validated models reach production while deprecated models are archived with full historical context.

The engagement decision system 1008 is communicatively coupled to the deployment service 1006 and is configured to receive updated models and incorporate them into the production engagement pipeline illustrated in FIG. 8, where they replace or augment existing models to provide improved predictions for action selection and channel scoring. The engagement decision system 1008 loads deployed model artifacts into inference engines that execute predictions in response to real-time engagement requests, applies newly deployed models to generate action recommendations and channel scores using the same feature generation and model inference architecture shown in FIG. 8, and continues to serve production traffic while capturing outcomes through the outcome capture service 1001 to provide training data for the next model training cycle. The engagement decision system 1008 implements model serving infrastructure that handles prediction requests with low latency appropriate for real-time messaging decisions, scales inference capacity to match engagement traffic volumes, and monitors model performance in production to detect degradation or drift that might trigger model retraining.

The identity database 1009 is communicatively coupled to the feature labeler 1003 and is configured to provide historical user behavior data that enriches training examples with long-term context beyond individual interaction events. The identity database 1009 stores persistent user identity profiles containing accumulated interaction history across multiple campaigns and sessions, prior conversion events with outcomes and revenue values, lifetime engagement patterns showing response rates and channel preferences, loyalty program status and tier progression, purchase history documenting product categories and transaction values, and derived behavioral features such as propensity scores or customer value classifications. The feature labeler 1003 queries the identity database 1009 to retrieve this historical context for users appearing in training data, incorporating features such as how many prior engagements occurred, what conversion rate the user has historically exhibited, what average order value the user generates, and what engagement patterns distinguish this user from population averages. This historical enrichment improves model ability to personalize predictions by learning how users with different historical profiles respond to various engagement approaches, enabling the model to recognize that high-value repeat customers may respond differently than first-time prospects, or that users with consistent engagement histories may be more receptive to sophisticated multi-step nurture sequences than sporadically engaged users.

The continuous learning pipeline illustrated in FIG. 10 creates a closed feedback loop where engagement decisions generate outcomes, captured outcomes inform model training, trained models are validated and deployed, deployed models power improved engagement decisions, and the cycle repeats indefinitely. This creates a self-improving system where prediction accuracy compounds over time as more outcome data accumulates, model training incorporates increasingly diverse examples representing different user segments and engagement contexts, validation procedures become more rigorous as edge cases are discovered and added to test suites, and deployment processes mature to handle model updates with minimal disruption and maximum safety. The dashed feedback arrow from the engagement decision system 1008 back to the outcome capture service 1001 illustrates this continuous cycle, showing how predictions made by deployed models generate new outcomes that immediately become training data for future model generations.

The architecture demonstrated in FIG. 10 transforms the engagement system from a static rule-based platform into a continuously learning intelligence that adapts to changing user behaviors, evolving campaign strategies, shifting market conditions, and emerging engagement patterns without requiring manual reconfiguration or expert intervention. By automating the complete machine learning lifecycle from outcome capture through training to deployment, the system ensures that engagement decisions always reflect the most current learnings about what actions and channels drive successful outcomes, creating a sustainable competitive advantage through accumulated intelligence that improves faster than manually optimized systems can adapt.

### Exemplary Computing Environment

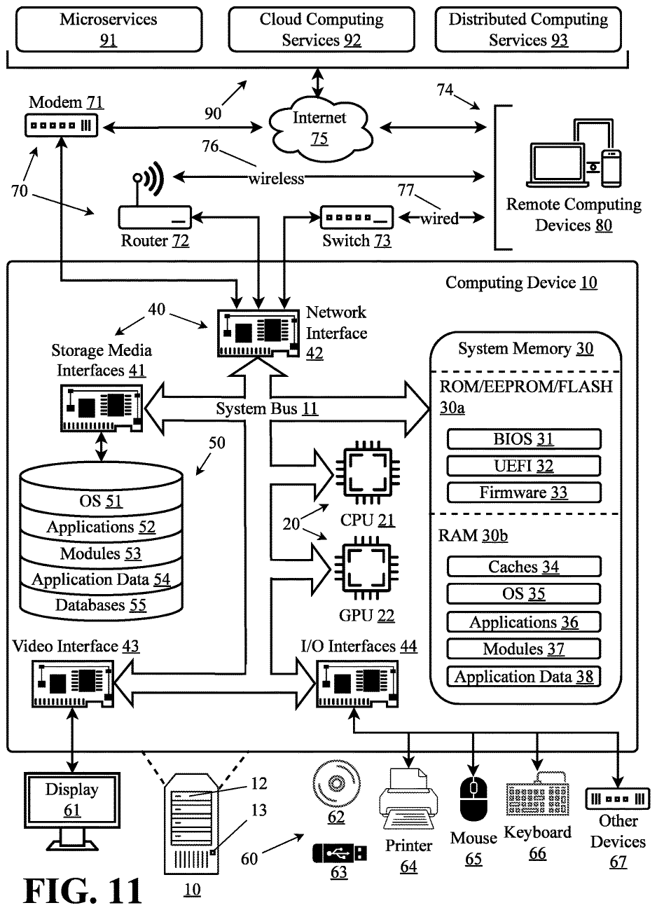

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A system for predictive engagement optimization with continuous learning and intelligent lead routing, comprising:
a user device comprising at least a first plurality of programming instructions stored in the memory of, and operating on at least one processor of, a first computing device, wherein the first plurality of programming instructions, when operating on the at least one processor, cause the first computing device to:
interact with digital activation assets over a network;
transmit an interaction event comprising a phone number and contextual data; and
receive an engagement message via a messaging protocol;
a messaging gateway comprising at least a second plurality of programming instructions stored in the memory of, and operating on at least one processor of, a second computing device, wherein the second plurality of programming instructions, when operating on the at least one processor, cause the second computing device to:
support multiple messaging protocols;
receive delivery instructions from an engagement decision server;
deliver the engagement message to the user device using a selected messaging protocol; and
capture engagement outcomes comprising message delivery confirmations, message open events, user responses, link clicks, and conversion events;
an engagement decision server comprising at least a third plurality of programming instructions stored in the memory of, and operating on at least one processor of, a third computing device, wherein the third plurality of programming instructions, when operating on the at least one processor, cause the third computing device to:
receive the interaction event from the user device comprising the phone number and contextual data;
retrieve an identity profile from an identity database using the phone number as a primary identifier, wherein the identity profile comprises accumulated interaction history and engagement patterns;
generate a feature representation derived from the identity profile and the contextual data;
apply a trained engagement model to the feature representation to determine a predicted next engagement action and a preferred communication channel;
evaluate communication channel capability information associated with the user device;
select the messaging protocol based on the preferred communication channel and the communication channel capability information;
generate the engagement message corresponding to the predicted next engagement action;
transmit delivery instructions to the messaging gateway;
receive the engagement outcomes from the messaging gateway;
aggregate the engagement outcomes with the feature representation to create labeled training examples; and
update the trained engagement model using the labeled training examples; and
a lead routing server comprising at least a fourth plurality of programming instructions stored in the memory of, and operating on at least one processor of, a fourth computing device, wherein the fourth plurality of programming instructions, when operating on the at least one processor, cause the fourth computing device to:
apply a conversion prediction model to the identity profile to compute a predicted conversion probability;
evaluate availability status of multiple lead destinations;
determine a routing destination based on the predicted conversion probability and the availability status; and
transmit lead data to the determined routing destination.

2. The system of claim 1, wherein the engagement decision server is further configured to determine predicted engagement probabilities for multiple candidate engagement actions and select the predicted next engagement action as the candidate engagement action having a highest predicted engagement probability.

3. The system of claim 1, wherein the engagement decision server is further configured to determine predicted engagement probabilities for multiple communication channels and select the preferred communication channel as the communication channel having a highest predicted engagement probability among channels satisfying capability and consent requirements.

4. The system of claim 1, wherein the feature representation comprises prior response rates for specific channels, historical interaction frequency, device capability indicators, time-of-day engagement likelihood, campaign context parameters, geographic location signals, loyalty status indicators, and prior purchase behavior.

5. The system of claim 1, wherein the lead routing server is further configured to retrieve historical performance metrics documenting conversion rates by destination type and incorporate the historical performance metrics into the routing destination determination.

6. The system of claim 1, wherein the engagement decision server is further configured to:
aggregate multiple labeled training examples into a training dataset;
execute a model training algorithm that optimizes model parameters to maximize predictive accuracy on the training dataset;
validate trained model performance on a held-out validation dataset;
determine whether the trained model satisfies acceptance criteria comprising minimum performance thresholds and statistically significant improvement over a current production model; and
deploy the trained model when the acceptance criteria are satisfied.

7. The system of claim 1, wherein the predicted next engagement action comprises at least one of presenting a product offer, sending an appointment scheduling link, requesting qualification information, routing to a live agent, delivering a loyalty incentive, or providing educational content.

8. The system of claim 1, wherein the engagement message comprises an interactive Rich Communication Services message including a message card and at least one action button when the selected messaging protocol is Rich Communication Services, or comprises a text-based message with numbered reply options when the selected messaging protocol is Short Message Service or Multimedia Messaging Service.

9. The system of claim 1, wherein the engagement decision server is further configured to maintain a session identifier associated with the interaction event and preserve session continuity across messaging protocol transitions when the selected messaging protocol becomes unavailable and a fallback messaging protocol is used for subsequent message delivery.

10. The system of claim 1, wherein the multiple lead destinations comprise at least one of a call center, a sales agent, an automated chat system, a customer relationship management system, or a loyalty management system.

11. A method for predictive engagement optimization with continuous learning and intelligent lead routing, comprising the steps of:
interacting with digital activation assets over a network, using a user device;
transmitting an interaction event comprising a phone number and contextual data, using a user device;
receiving an engagement message via a messaging protocol, using a user device;
supporting multiple messaging protocols, using a messaging gateway;
receiving delivery instructions from an engagement decision server, using a messaging gateway;
delivering the engagement message to the user device using a selected messaging protocol, using a messaging gateway;
capturing engagement outcomes comprising message delivery confirmations, message open events, user responses, link clicks, and conversion events, using a messaging gateway;
receiving the interaction event from the user device comprising the phone number and contextual data, using an engagement decision server;
retrieving an identity profile from an identity database using the phone number as a primary identifier, wherein the identity profile comprises accumulated interaction history and engagement patterns, using an engagement decision server;
generating a feature representation derived from the identity profile and the contextual data, using an engagement decision server;
applying a trained engagement model to the feature representation to determine a predicted next engagement action and a preferred communication channel, using an engagement decision server;
evaluating communication channel capability information associated with the user device, using an engagement decision server;
selecting the messaging protocol based on the preferred communication channel and the communication channel capability information, using an engagement decision server;
generating the engagement message corresponding to the predicted next engagement action, using an engagement decision server;
transmitting delivery instructions to the messaging gateway, using an engagement decision server;
receiving the engagement outcomes from the messaging gateway, using an engagement decision server;
aggregate the engagement outcomes with the feature representation to create labeled training examples, using an engagement decision server;
update the trained engagement model using the labeled training examples, using an engagement decision server;
apply a conversion prediction model to the identity profile to compute a predicted conversion probability, using a lead routing server;
evaluate availability status of multiple lead destinations, using a lead routing server;
determine a routing destination based on the predicted conversion probability and the availability status, using a lead routing server; and
transmit lead data to the determined routing destination, using a lead routing server.

12. The method of claim 11, wherein the engagement decision server is further configured to determine predicted engagement probabilities for multiple candidate engagement actions and select the predicted next engagement action as the candidate engagement action having a highest predicted engagement probability.

13. The method of claim 11, wherein the engagement decision server is further configured to determine predicted engagement probabilities for multiple communication channels and select the preferred communication channel as the communication channel having a highest predicted engagement probability among channels satisfying capability and consent requirements.

14. The method of claim 11, wherein the feature representation comprises prior response rates for specific channels, historical interaction frequency, device capability indicators, time-of-day engagement likelihood, campaign context parameters, geographic location signals, loyalty status indicators, and prior purchase behavior.

15. The method of claim 11, wherein the lead routing server is further configured to retrieve historical performance metrics documenting conversion rates by destination type and incorporate the historical performance metrics into the routing destination determination.

16. The method of claim 11, wherein the engagement decision server is further configured to:
aggregate multiple labeled training examples into a training dataset;
execute a model training algorithm that optimizes model parameters to maximize predictive accuracy on the training dataset;
validate trained model performance on a held-out validation dataset;
determine whether the trained model satisfies acceptance criteria comprising minimum performance thresholds and statistically significant improvement over a current production model; and
deploy the trained model when the acceptance criteria are satisfied.

17. The method of claim 11, wherein the predicted next engagement action comprises at least one of presenting a product offer, sending an appointment scheduling link, requesting qualification information, routing to a live agent, delivering a loyalty incentive, or providing educational content.

18. The method of claim 11, wherein the engagement message comprises an interactive Rich Communication Services message including a message card and at least one action button when the selected messaging protocol is Rich Communication Services, or comprises a text-based message with numbered reply options when the selected messaging protocol is Short Message Service or Multimedia Messaging Service.

19. The method of claim 11, wherein the engagement decision server is further configured to maintain a session identifier associated with the interaction event and preserve session continuity across messaging protocol transitions when the selected messaging protocol becomes unavailable and a fallback messaging protocol is used for subsequent message delivery.

20. The method of claim 11, wherein the multiple lead destinations comprise at least one of a call center, a sales agent, an automated chat system, a customer relationship management system, or a loyalty management system.
